(19) United States
(12) Patent Application Publication
(10) Pub. No.: US 2014/0258832 A1
(43) Pub. Date: Sep. 11, 2014

(54) Computer Implemented System and Method for Author Editing of XML Documents With Structured Element Protection

(71) Applicant: Dartmouth Journal Services, Inc., (unknown)

(72) Inventors: Michael James Hepp, Montpelier, VT (US); Charles William O'Connor, Cabot, VT (US); Antony Muthu Raja Gnanapiragasam, Waterbury, VT (US); William Clarke, Florence, MA (US)

(73) Assignee: Dartmouth Journal Services, Inc.

(21) Appl. No.: 13/792,922

(22) Filed: Mar. 11, 2013

(51) Int. Cl. G06F 17/24

(52) U.S. Cl. CPC G06F 17/24
USPC 715/234

(57) ABSTRACT

Embodiments of the present invention provide an interactive, computer implemented and networked system and method for editing highly structured XML-based documents adapted for online journal publication. The present invention is capable of handling multimedia rich content while enforcing protection of highly structured elements to maintain document integrity through the proofing process. Embodiments of the present invention thus provide a graphical user interface (“GUI”) to facilitate the proof/editing process, which not only enforces the highly structured element protection, but also provides author-users with a familiar, word processor-like experience while eliminating the need for annotated PDF documents to preserve the structured content.

### FIELD OF THE INVENTION

The present invention generally relates to a computer implemented system and method for editing XML (eXtensible Markup Language) documents while enforcing valid document structure and is particularly well suited for network based publishing systems. More particularly, the present invention relates to such a system and method in which select elements are protected during editing and a graphical user interface that facilitates editing while enforcing said protection.

### BACKGROUND

Publishing has traditionally meant typeset, printed publications presented in bound paper journals or books. However, with the growing popularity of the Internet and the concomitant introduction of the online journal, publishers have increased their focus on expanding the content offering online and continue to do so at ever increasing rates. As a result of the increased focus on online journals, publishers have reduced their focus on traditional, printed publications. Along with this shift in focus, pressure to improve online offerings in recent years has grown significantly. While the reduction or elimination of traditional print runs by switching the same content to an online presentation is one way to increase online offerings, such an approach does not take full advantage of online content capabilities. In the print-centric world, the page had come to be defined as the content that could be displayed within a pre-defined page size for optimal reading performance. In contrast, the online “page” is defined as the content or content references that can be displayed within a given browser view, including links or interactive multi-media content that engages and can be controlled by the user. As a result, the composition of a “page” no longer has to be limited to the constraints of a printed journal page and instead can leverage the capabilities of the browser or HTML display to include multimedia content, navigation links and other formats not well-suited to the static page.

A commonly-used language to author, maintain and manage content is XML. XML is a W3C Recommendation approved in 1998 and is a derivative of Standard Generalized Markup Language, or “SGML,” an ISO Standard (8879:1986). The overarching principle behind both SGML and XML is the separation of content (the data) from format (the presentation). This is usually accomplished by defining a vocabulary (elements) and an associated grammar (the rules by which those elements may be used). There are several methods for specifying the vocabulary and grammar; a DTD is the most common in the publishing industry, although a W3C Schema or RELAX NG may also be used. There are dozens of industry-standard DTDs in use as well as hundreds of customer-centric proprietary ones. The National Library of Medicine was responsible for creating a tag suite specifically for journals; several versions of the NLM Tag Suite (http://dtd.nlm.nih.gov/) are in wide use. The new JATS (Journal Article Tag Suite) (http://jats.nlm.nih.gov/) model, which is based on NLM 3.0, is both a NISO (Z39.96-2012) and ANSI standard. This makes XML a very powerful language that enables users to easily define a data model for the content, which may change from one document to another. Combining the XML-tagged document with a CSS (Cascading Style Sheet), the document can be displayed in a web browser or application. There are other methods to format an XML document, such as using XSL-FO to create a composed PDF, or using a composition/page layout system that is XML-aware.

An application receiving an XML document processes an XML schema along with the XML encoded document to validate the content and its presentation, e.g., to ensure that the document adheres to the data model defined by the schema. (While the term “document” is used herein for ease of reference, information represented using XML may comprise any type of electronically presentable information, and is not limited to the traditional interpretation of the word “document”.) Because of its power and flexibility, XML can be used to create multimedia rich content for online journals, with interactive links and enhanced navigation. But the features that give XML that power and flexibility also present unique process challenges for online journals, especially those that rely on diverse authorship and, in particular, authors who may have no knowledge of XML.

Traditionally, a printed journal would receive content from authors in the form of written manuscripts. The manuscripts would be copy edited to produce proofs for review by the author (and proof readers). Originally, when printing meant typesetting, the proofs, sometimes called galley proofs, were presented in individual, unbound pages and delivered to the author for review. More recently, as publishing became more electronic, proofs would be provided electronically to the authors as PDF documents (portable document format). The authors would then review the proofs and indicate any corrections by marking-up the documents. Again, the form of mark-ups evolved from pen on paper to electronic mark-ups on PDF documents. But always consistent throughout this evolution were two factors: the content was based on the boundaries and limitations of the printed page and the markups by authors were marked on the printed page and interpreted by the publisher for inclusion in the printed version. Even as journals turn to more online content, the proofing process for authors still is largely a page focused process involving marking-up electronically delivered PDF documents.

However, when content is presented for online publication to take advantage of the power of XML and web-based presentation, the manuscript is generally converted to XML as part of the copy editing process. But then, because the process generally remains page focused, the XML is rendered as a composed page by a composition system and the document is provided as a PDF document for proofing and mark-up by the author. When the publisher receives back the author's mark-ups, the corrections are made directly to the underlying XML in the composition system, which is then exported for online publishing. Not only does this process involve extra work, it also does not permit the author to see the content in the same way that it would be presented online. While it may seem a simple thing to let the author edit the XML version of the document, it is anything but that.

Because of the nature of XML, the document that an author would be asked to edit will contain XML coding (e.g., element and attribute tags, Unicode values for special characters) and potentially much more data only some of which an author needs to be exposed to for typical proofing purposes. For example, the XML document may be defined by a standard DTD that has many elements and their associated attributes representing metadata, or information about the document itself, as well as dense markup to identify unique components in references and citations. In such a case, the author will need to edit only a small portion of the information contained in the document, but is still exposed to many details that should not be of concern to the author. If the author mistakenly deletes just a single character in the wrong place, an entire figure can disappear or other equally undesirable contextual changes occur. But perhaps more significantly, an author unfamiliar with XML, and even those with some knowledge of XML, can easily place the entire document in an unstable state by editing the XML file incorrectly. While there are a variety of XML editors available, ranging from basic ASCII text editors to customized WYSIWYG GUI editors that support XML markup, none are particularly well suited to the online journal publishing environment. Most XML editors still require a basic knowledge of XML and are not particularly user friendly for users such as authors with a longstanding familiarity with the proof mark-up process. There is thus a need for a XML editing system that is well suited to online journal publication and use by authors who may have little or no familiarity with XML or similar web-based markup languages.

### SUMMARY OF THE DISCLOSURE

In one implementation, the present disclosure is directed to a computer-implemented method for restricted editing of documents containing highly structured elements (HSEs) provided across a network. The method includes initiating an authenticated editing session at a client to permit user editing of a remotely provided document containing at least one HSE, the document being correlated to the authenticated editing session; receiving the document at the client from a remote associated server system via the network; displaying at the client a first display interface presenting the document and permitting direct editing of non-HSE portions of the document; displaying at the client at least one second display interface presenting the at least one HSE for editing in accordance with a restricted editing protocol (REP) corresponding to the document; providing in the first display interface a first set of tools suitable for direct user editing of the non-HSE portions within the first display interface; providing in the second display interface at least one second set of restricted editing tools configured to permit user editing of a presented HSE in accordance with the REP, wherein the at least one second set of restricted editing tools is specifically configured for a corresponding HSE; editing the document using the first and second sets of tools in accordance with the REP to create an edited document; transmitting the edited document to the remote associated server via the network; and terminating the authenticated editing session after the editing.

In another implementation, the present disclosure is directed to a computer-implemented method for restricted remote editing across a network of documents containing highly structured elements (HSEs). The method includes receiving authentication credentials at a server from a remote client; initiating an authenticated remote client editing session based on authentication of the credentials at the server; identifying a document containing HSEs corresponding to the authenticated credentials; transmitting instructions to the remote client for configuring the remote client as a restricted editing graphical user interface (REGUI), the set of instructions comprising instructions for configuring the remote client to display a first display interface for presenting the document and permitting direct editing of non-HSE portions of the document, configuring the remote client to display a second display interface for presenting at least one HSE for editing in accordance with a restricted editing protocol (REP), providing in the first display interface a first set of tools suitable for direct user editing of the non-HSE portions within the first display interface, providing in the second display interface at least one second set of restricted editing tools configured to permit user editing of a presented HSE in accordance with the REP, wherein the at least one second set of restricted editing tools is specifically configured for a corresponding HSE, and transmitting the user entered edits from the remote client to the server via the network; transmitting the identified document to the remote client for display and editing in accordance with the REP; receiving the user entered edits from the remote client; and terminating the authenticated remote client editing session upon receipt of a completion notification.

In still another implementation, the present disclosure is directed to a network-based system for restricted remote editing of document containing highly structured elements (HSEs). The system includes at least one storage medium configured to store at least one document containing at least one HSE and instructions to configure the system for restricted remote editing of the at least one document, the instructions comprising instructions for a) authenticating user credentials received from the remote client, b) retrieving a document from the storage device corresponding to the authenticated credentials, c) determining a restricted editing protocol (REP) corresponding to the retrieved document, d) transmitting REP instructions to the remote client for configuring the remote client as a restricted editing graphical user interface (REGUI) corresponding to the determined REP, the REP instructions comprising instructions for configuring the remote client to display a first display interface for presenting the document and permitting direct editing of non-HSE portions of the document, configuring the remote client to display a second display interface for presenting at least one HSE for editing in accordance with the REP, providing in the first display interface a first set of tools suitable for direct user editing of the non-HSE portions within the first display interface, providing in the second display interface at least one second set of restricted editing tools configured to permit user editing of a presented HSE in accordance with the REP, wherein the at least one second set of restricted editing tools is specifically configured for a corresponding HSE, and transmitting the user edited document to an associated server system via the network, and e) transmitting the retrieved document to the remote client for display and editing in accordance with the REP; a network interface configured for communication with a remote client through which user editing of the document is to be performed; and a processor communicating with the at least one storage medium and network interface, the processor configured to execute the instructions.

In yet another implementation, the present disclosure is directed to a computer-implemented method for tracking changes in XML coded files. The method includes receiving information representing one or more changes to an original file, wherein the information comprises at least one content change and at least one attribute value associated with each the change; processing the original file in accordance with the received content changes while maintaining the association between each the content change and the at least one associated attribute value, wherein the processing comprises tagging the file in accordance with an associated change schema for the file to produce a changed file reflecting the content changes; receiving a change tracking request with respect to the changed file; and generating a change tracked version of the changed file in response to the change tracking request, wherein the tracked change file represents the content changes in a denormalized tagging format.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a diagrammatic representation of a web-based publishing system for producing online journal content utilizing embodiments of the present invention.

FIG. 2 is a diagrammatic representation of a content management system—author client interaction according to an exemplary embodiment of the present invention.

FIG. 3 is a flow diagram illustrating an exemplary process for author editing according to an embodiment of the present invention.

FIG. 3A is a further flow diagram illustrating optional, alternative steps that may be included with the steps of FIG. 3.

FIGS. 4A-N are screen shots of a graphical user interface as displayed at the author client according to an exemplary embodiment of the present invention.

FIG. 5 is a diagrammatic representation of a computing device suitable for use as a content management system according to an exemplary embodiment of the according to the present invention.

### DETAILED DESCRIPTION

Embodiments of the present invention provide an interactive, computer implemented and networked system and method for editing structured documents adapted for online journal publication and capable of handling multimedia rich content, while enforcing protection of key elements to maintain document integrity throughout the proofing process. “Protection” as used herein with respect to editing of highly structured elements refers to a variety of processes including preventing some elements from being edited, preserving the complex tagging structure of select elements edited through a restricted graphical user interface, creating complex tagging structures where appropriate consistent with required formatting when information is added to a document during editing, and formatting specific tagging structures based on journal-specific configuration files as described herein.

Embodiments of the present invention provide a graphical user interface (“GUI”) to facilitate the proof/editing process which not only enforces document structure, but also provides author-users with a familiar, word processor-like experience while eliminating the need for annotated PDF documents to preserve the structured content. In one aspect of the invention, elements generally, other than highly structured elements (“HSE”), may be edited through the GUI directly by an author-user with word processor-like tools. Editing of HSEs, however, is restricted by the GUI to preserve document integrity because of their complexity and the high probability of document corruption if incorrectly edited. HSEs are thus editable only through controlled windows or widgets that limit the author-user's edits to schema compliant corrections. As used herein, “element” generally refers to any XML element with start and end tags. Element identifiers associated with paragraphs, titles, section headings, and figure captions are common examples. HSE, as used herein, refers to an element structure that includes, but is not limited to, plural, nested sub-elements, each with their own start and end tags. Examples of HSEs may include figures, tables, references and citations. A general familiarity with XML and related specifications as would be possessed by a person of ordinary skill in the art is presumed and necessary for a full understanding of the present invention. There are numerous XML vocabularies and grammars in use and the principles of the present invention would generally apply to any document conforming to the XML Recommendation.

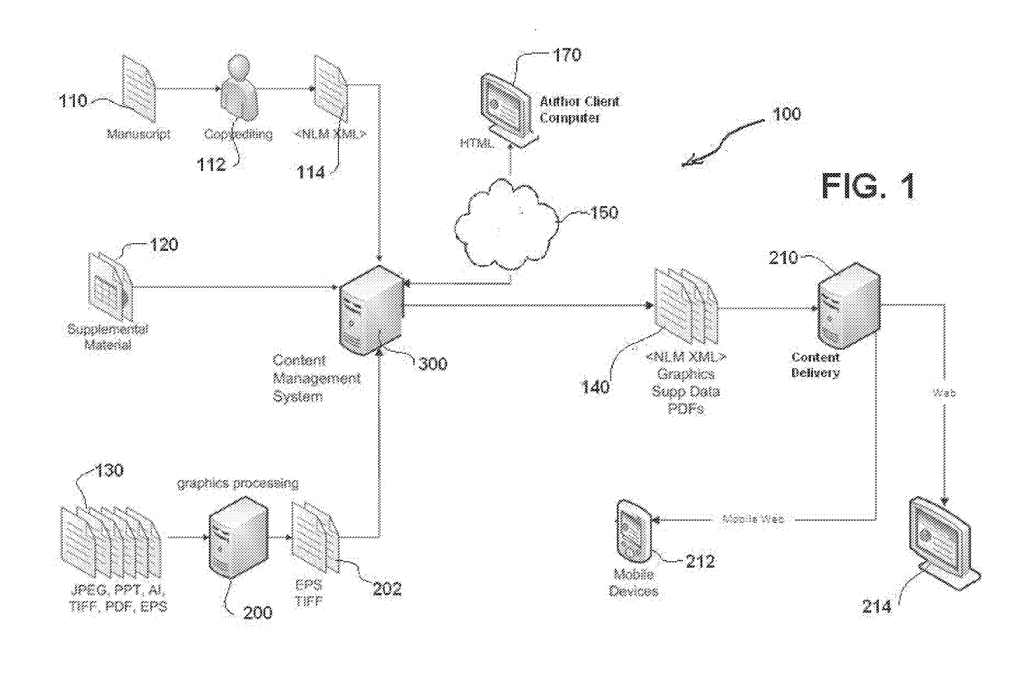

Referring first to FIG. 1, a work flow for system 100 according to one exemplary embodiment of the present invention begins with receiving manuscript 110. This aspect is the same for online publishing as it has been for printed journals generally since the beginning of publishing. The manuscript undergoes copy editing 112, which is again similar in many respects to traditional publishing except that copy editing in the present invention is done with a view to producing web-based content that takes advantage of all the content rich features offered by HTML web-based displays. In particular, edited documents may be converted from whatever native format the manuscript was provided into an XML document.

XML document 114 is received by the content management system (“CMS”) 300. CMS 300 may serve a variety of purposes. In the exemplary embodiment shown in FIG. 1, CMS 300 not only receives copy edited XML document 114, it also integrates supplemental material 120 from a variety of sources, such as video and audio files, or supplemental text in XML format, and graphics from the graphics processing 200. Graphics processing 200 may utilize known image processing systems to format image source material 130 as compatible with the XML document. Formatted images 202 are typically rendered as TIFF or EPS, although author supplied images 130 may be received in any number of known image formats. CMS 300 uses known electronic publishing techniques to synthesize the various inputs (114, 120, 202) to create journal content. However, before providing finished content 140 for delivery to clients, a proof version is transmitted via communications network 150 to an Author Client 170. Most commonly, network 150 may comprise the Internet, but, especially in large organizations, such a network may be an internal proprietary network. In general, embodiments of the present invention may be applied to any networked communication system. Whether the network is public or private, communications between CMS 300 and Author Client 170 may be encrypted or provided with other secure transmission means as known to persons skilled in the art. Functionality and protocols for communicating XML structured documents to Author Client 170 via network 150 are described in more detail below.

After the author has approved the final proof (traditionally sometimes referred to as a page proof), CMS 300 manages the final content preparation to produce Final Content 140 in desired format for client delivery. In one embodiment, the final content is in the form of JATS 1.0 Journal Publishing Tag Set XML documents for conversion and display on web-based fixed and mobile devices 212, 214. While JATS 1.0 Journal Publishing Tag Set XML and other XML vocabularies and grammars may be employed, CMS 300 retains flexibility to produce the content in HTML or more traditional PDF format as may be desired by particular journals. A separate content delivery system 210 may be used to manage delivery of content to mobile clients 212 and fixed client computers 214 via appropriate web or network communications protocols as will be understood by persons of ordinary skill in the art. The function of the content delivery system 210 also may be incorporated into CMS 300.

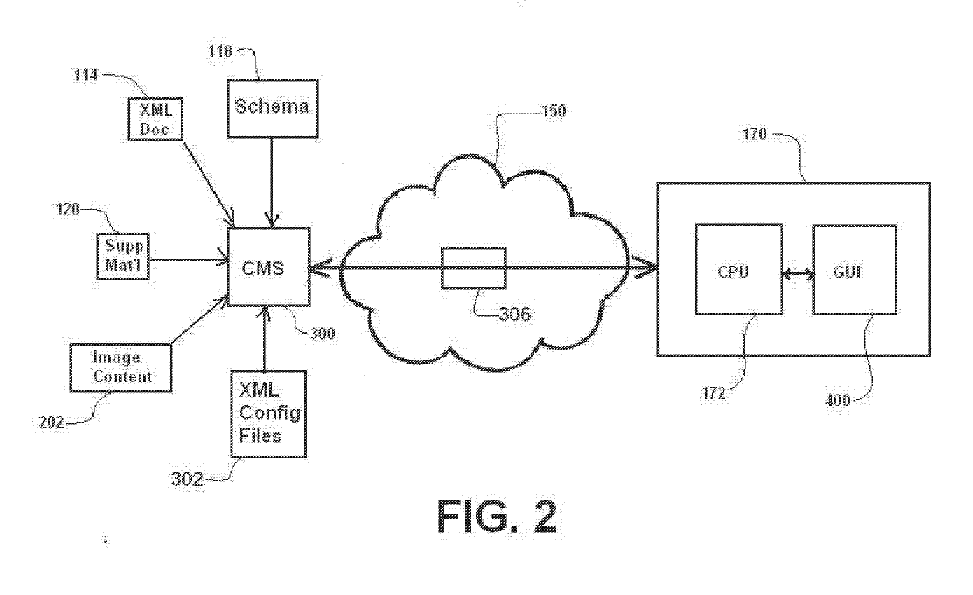

Details of the proofing functionality will now be discussed with reference first to FIG. 2. As shown therein, CMS 300 receives inputs from a variety of sources. As discussed above, it receives the basic XML document 114 from the copy editing function, any applicable supplemental materials 120 and image content 202 from the graphics processing system 200. In addition to these inputs, CMS is provided with a schema 118 for the specific XML vocabulary and grammar utilized. As previously mentioned, and as well known in the art, the schema defines the elements and their attributes, as well as the rules related to their usage, of a valid (conforming to the schema) XML document. In exemplary embodiments of the present invention, the schema may be customized to allow for additional features such as display and editing of main article and compose-able supplemental data in the same editing session, addition of all tracking information needed for Author Queries or comments, as discussed below, and/or addition of media attributes to support figure replacement.

A further input to CMS 300 are XML Configuration Files 302. The XML Configuration Files are journal-specific configuration files that include specific restrictions to be enforced at Author Client 170 in the editing of Proof Document 306 generated by CMS 300. Using XML Configuration Files 302 in conjunction with schema 118, CMS 300 generates HTML Proof Document 306 based on the provided inputs, i.e., XML document 114 and additional materials such as image content 202 and supplemental materials 120. Also based on Configuration Files 302, which as explained are journal-specific, CMS 300 creates a set of JavaScript-based tools and cascading style sheets (CSS) with Proof Document 306 that control the presentation of the proof document and permitted editing in accordance with a restricted editing protocol (REP) based on parameters dictated by the journal. The restricted editing protocol will typically be unique to the journal (and its documents) with which it is associated. However, it is contemplated that various journals may have editing protocols with common elements within their unique protocols. At a minimum each protocol will be unique based on its specific association with a particular journal or set of journals.

CMS 300 transmits Proof Document 306 with its journal-specific set of JavaScript-based tools and CSS to the authenticated client via network 150. Proof Document 306 is received by Author Client 170 and processed via CPU 172 or other known computing devices to generate and display Proof Document 306 in HTML in a Restricted Editing Graphical User Interface (“REGUI”) 400, which enforces the editing requirements and restrictions for the journal in compliance with the restricted editing protocol enforced by the journal specific JavaScript-based tools and CSS. REGUI 400 thus enforces specific editing restrictions and preset templates for each journal. For example, restrictions or templates based on general journal style may be encoded into an ArticleConfig.xml file, those pertaining to references encoded in a References.xml file, and those related to footnotes provided in a Footnotes.xml file. In another example, a Tagger.xml file may define the XML structures that can be added manually through a customizable tagging tool. Further control may be enforced with an AccessControl.xml file to enforce journal policy by restricting the editing of particular elements by particular actors. Features and functionality of the REGUI 400 will be described in detail below. In general, the use of XML schema and configuration files to create JavaScript-based tools and CSS in conjunction with an HTML presentation to configure a remote client for a particular purpose is understood by persons of ordinary skill in the art. Based on the teachings of the present invention as illustrated by the exemplary embodiments described herein, persons of ordinary skill in the art will be able to specifically program the REGUI 400 as described herein.

In an alternative embodiment, rather than schema 118, a DTD may be employed as is known in the art. In such an embodiment, a further input to CMS 300, in place of XML Configuration Files 302, may be a Bounding DTD. In this case, Bounding DTD would be a specifically written DTD that includes restrictions to be enforced at Author Client 170 on the editing of XML Proof Document 306 generated by CMS 300. Using such a Bounding DTD, CMS 300 would generate journal-specific XML Bounding Files. The XML Bounding Files are then processed by Author Client 170 via CPU 172 or other known computing device to generate a Restricted Editing Graphical User Interface (“REGUI”) 400 at the Author Client 170. The general use of a bounding DTD to generate a XML bounding file to restrict editing of XML documents is described, for example in Published US Patent Application No. 2004-0177315 A1, entitled “Structured Document Bounding Language,” which is incorporated herein by reference in its entirety. In the same manner as described above, after XML Proof Document 306 is approved and/or edited at the Author Client 170 through REGUI 400, the approved proof document containing edits is communicated back to CMS 300 through network 150, again using standard network communication protocols appropriate to the network type.

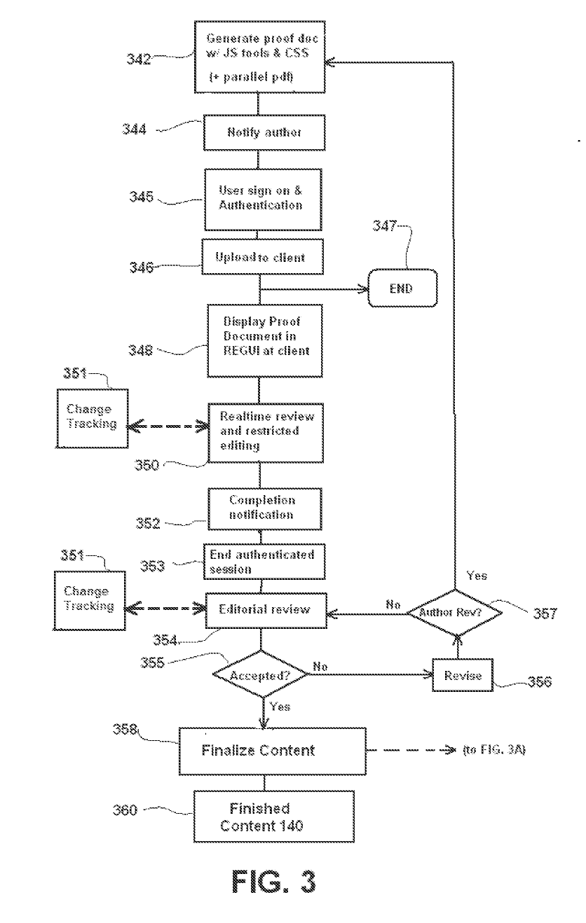

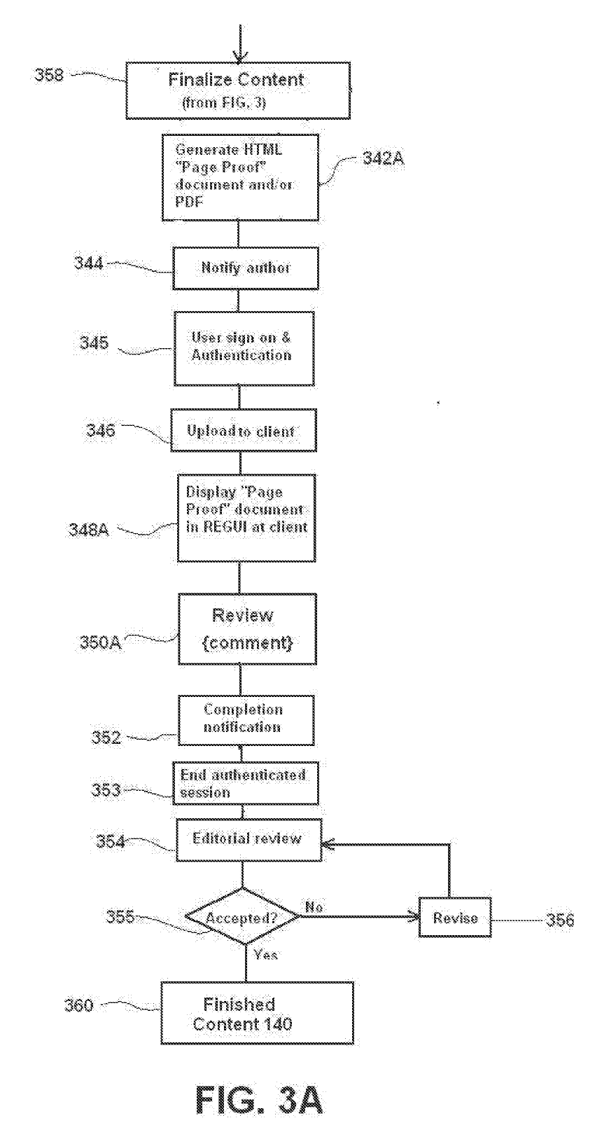

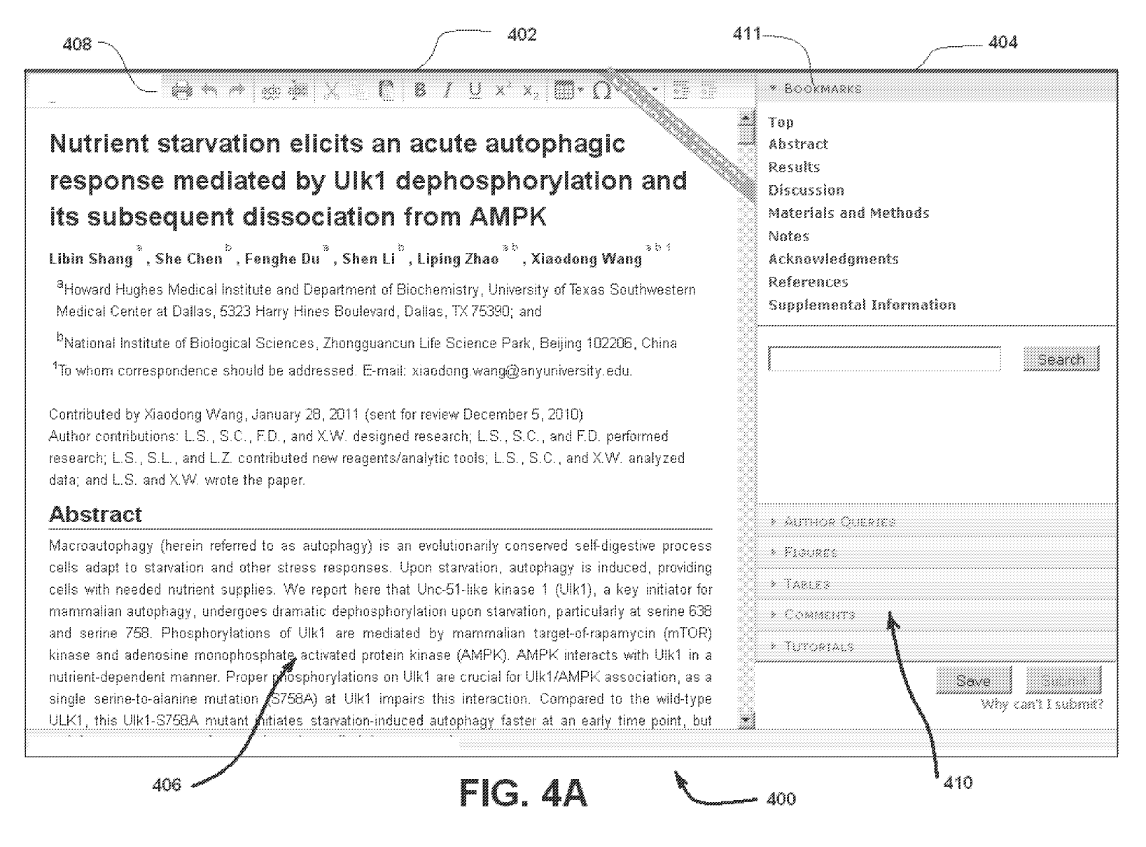

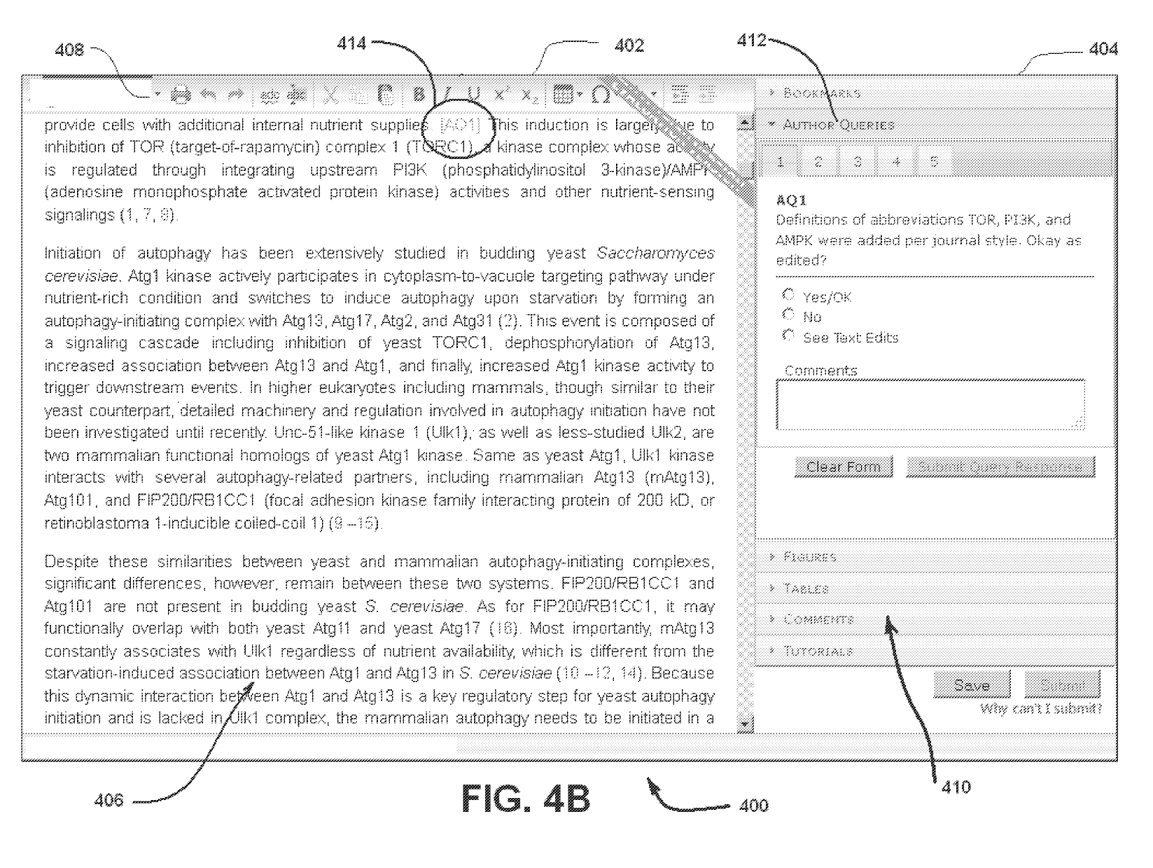

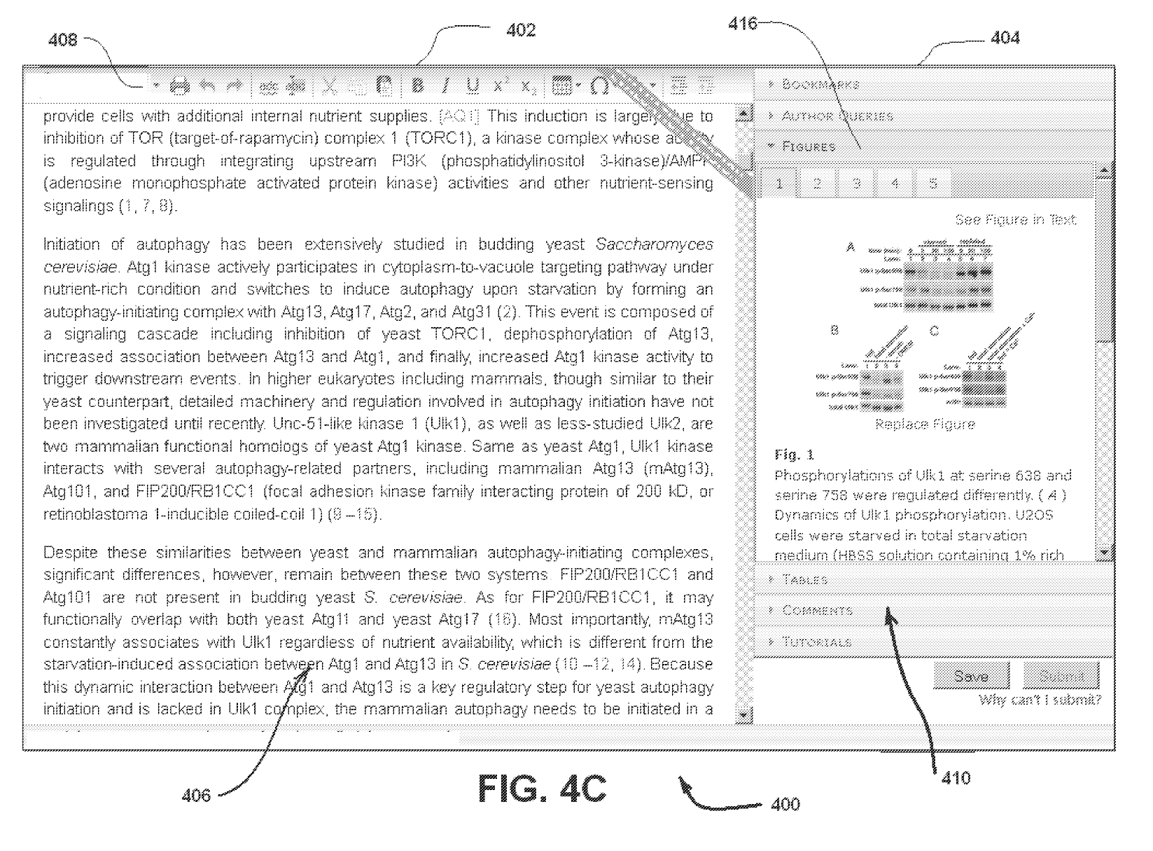

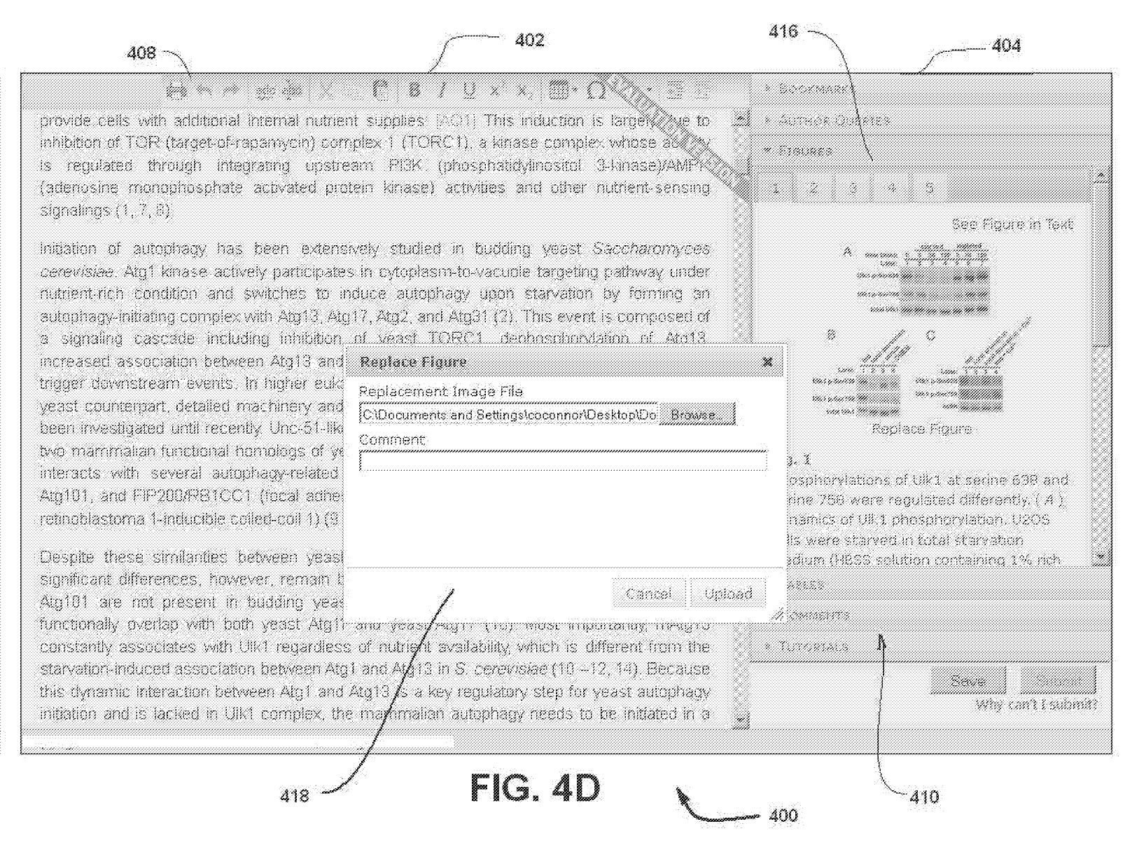

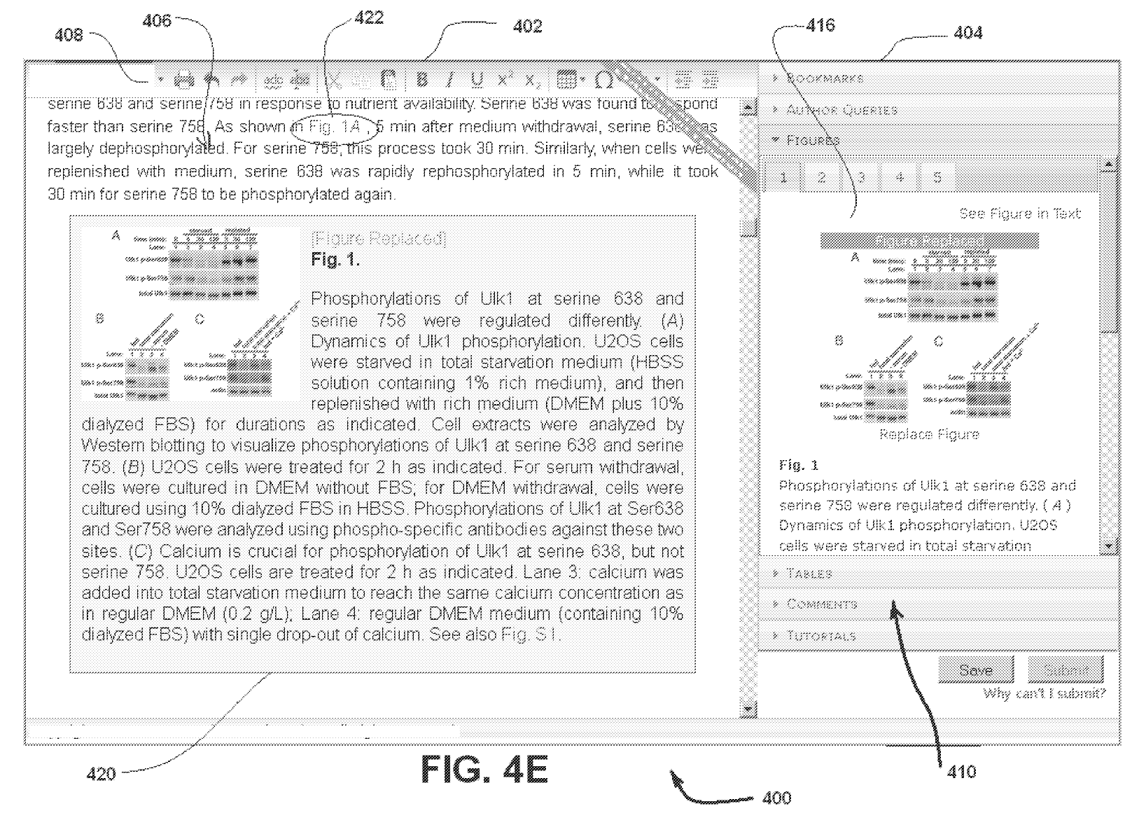

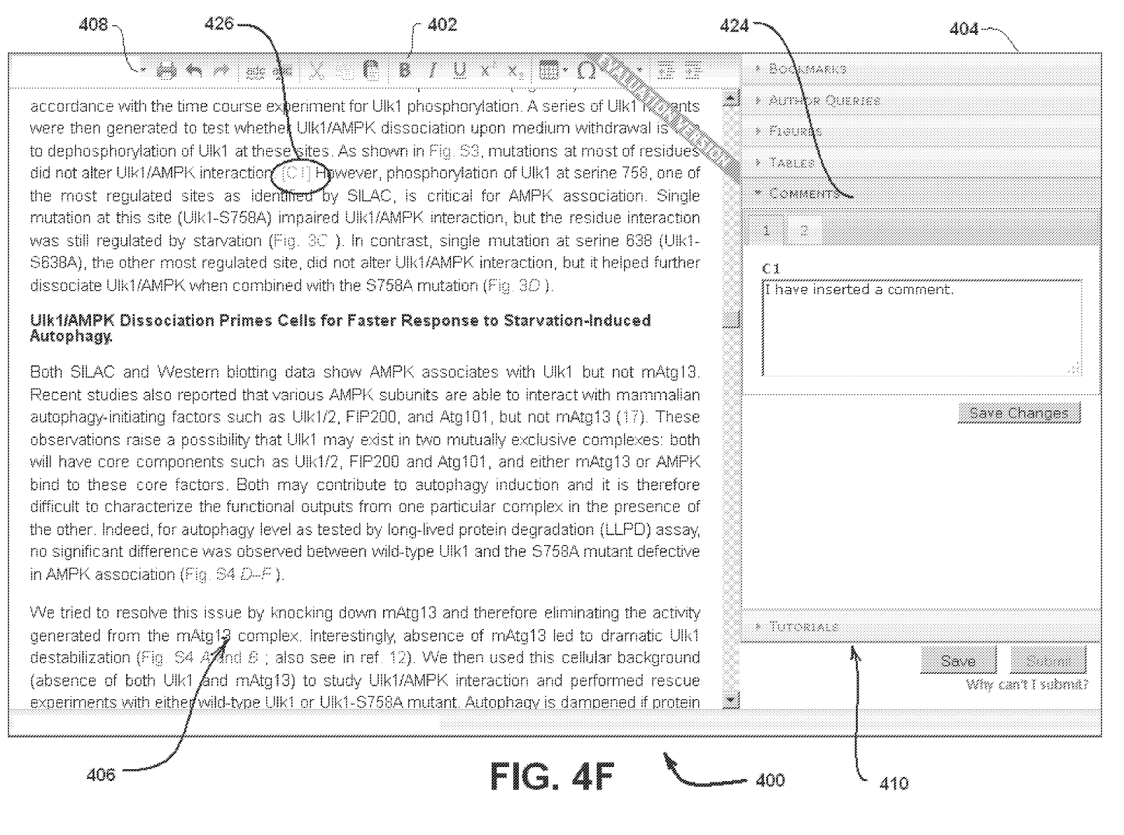

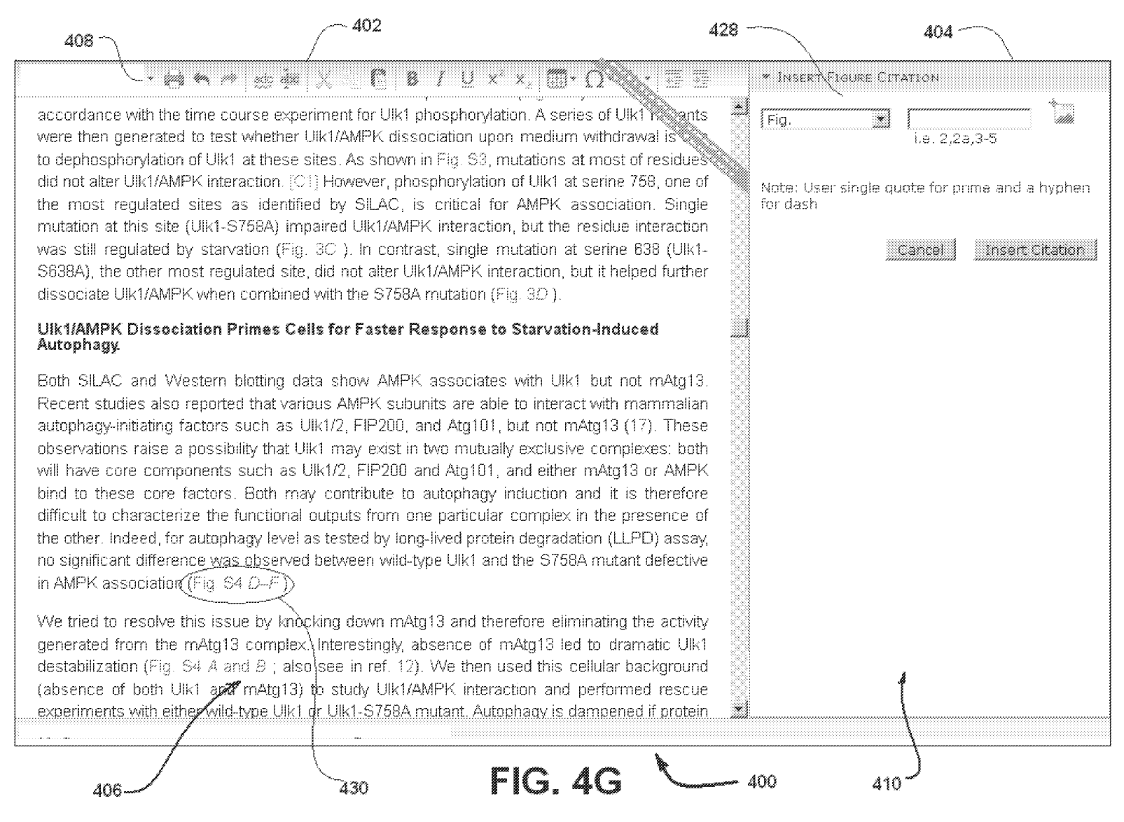

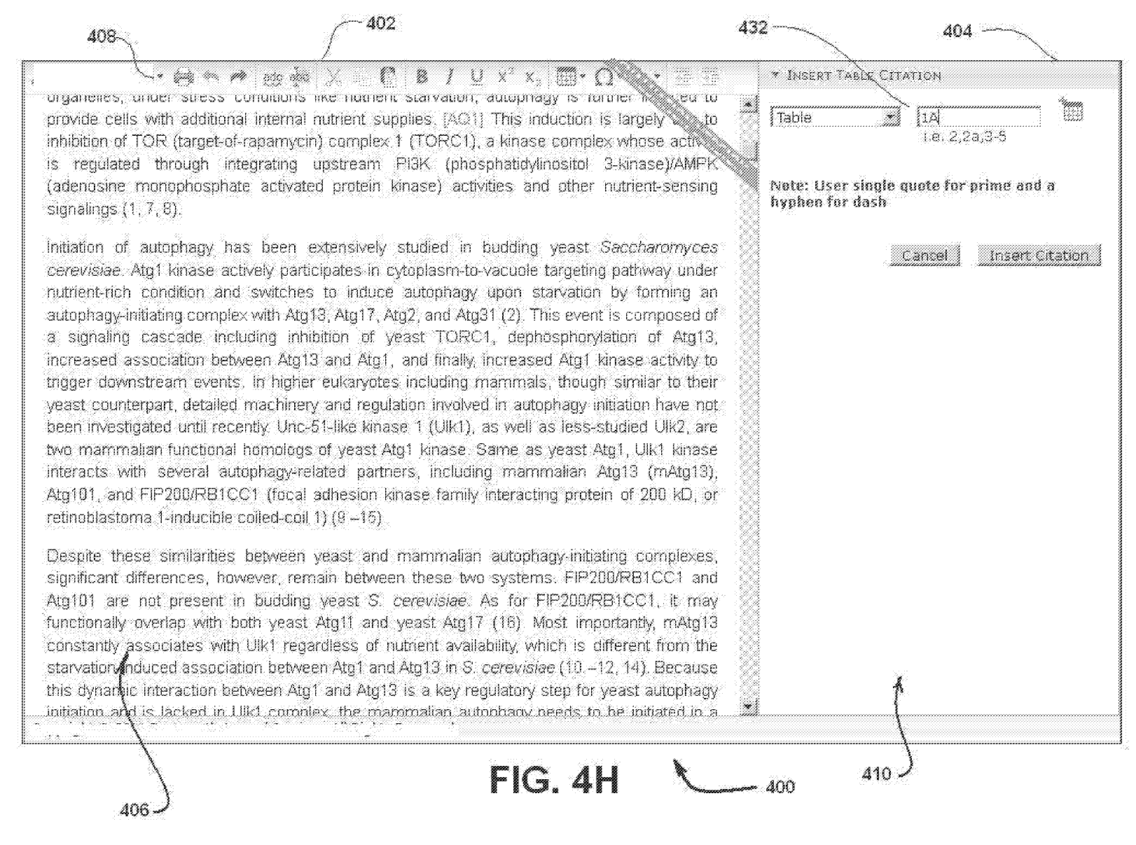

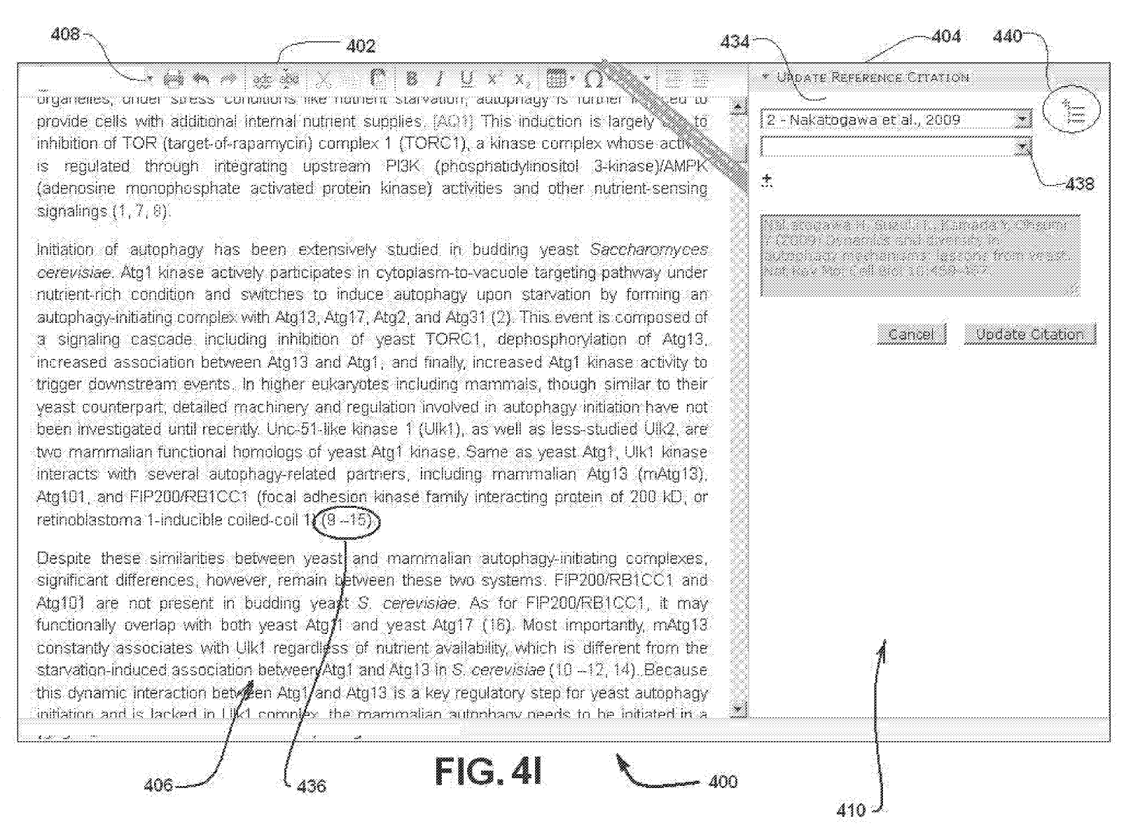

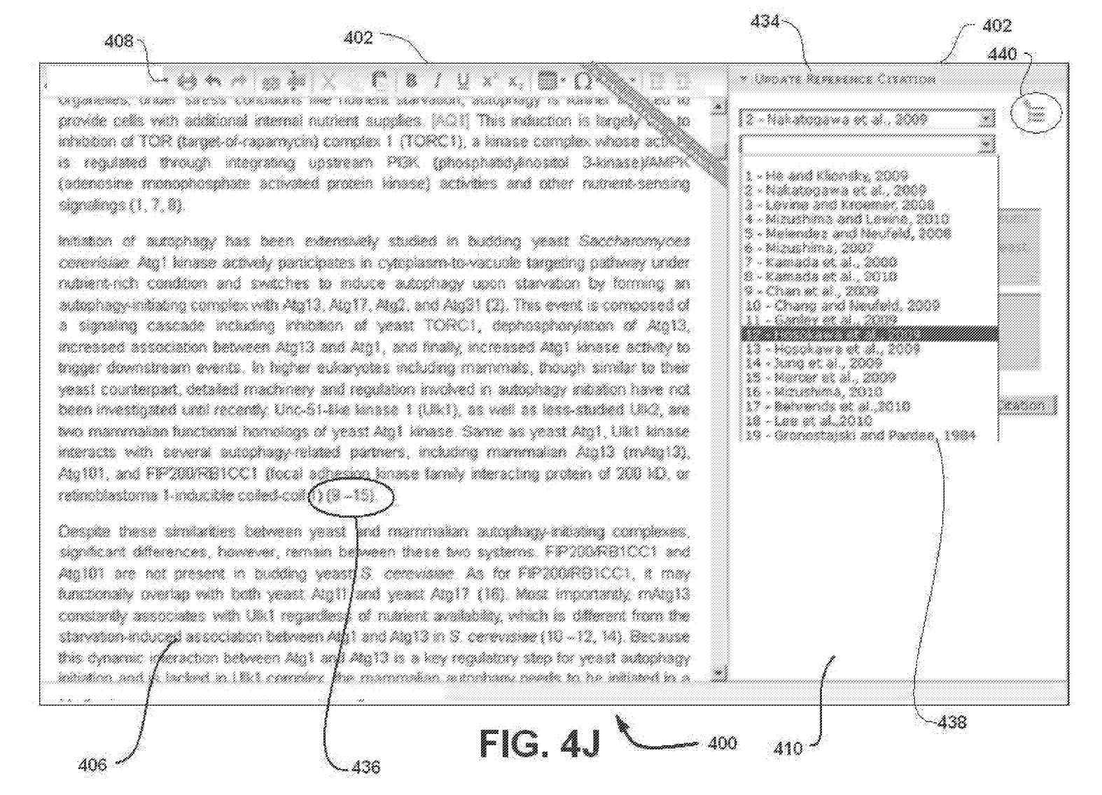

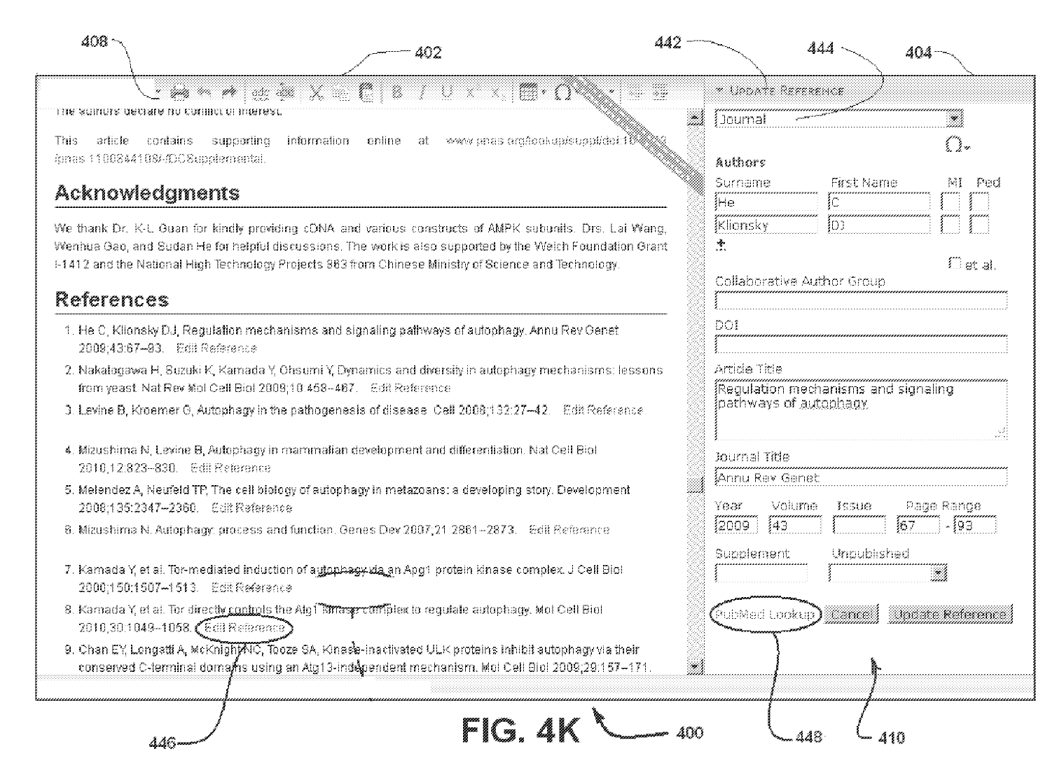

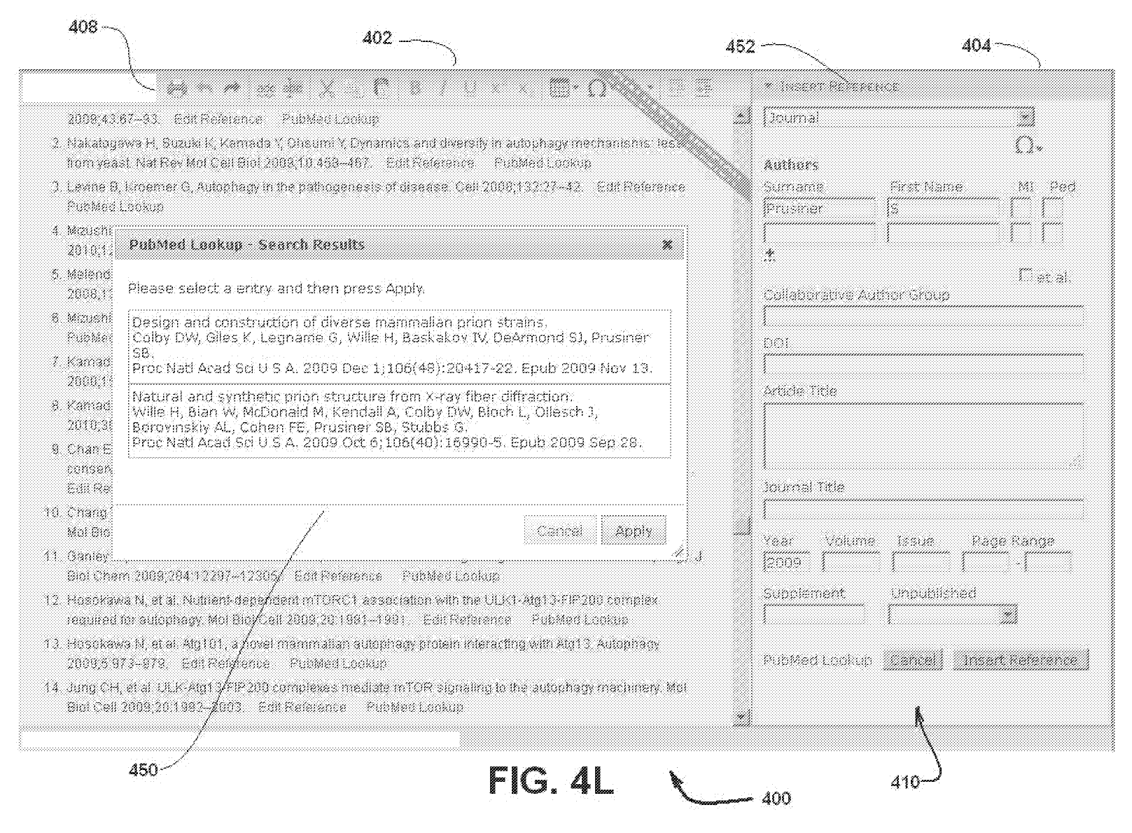

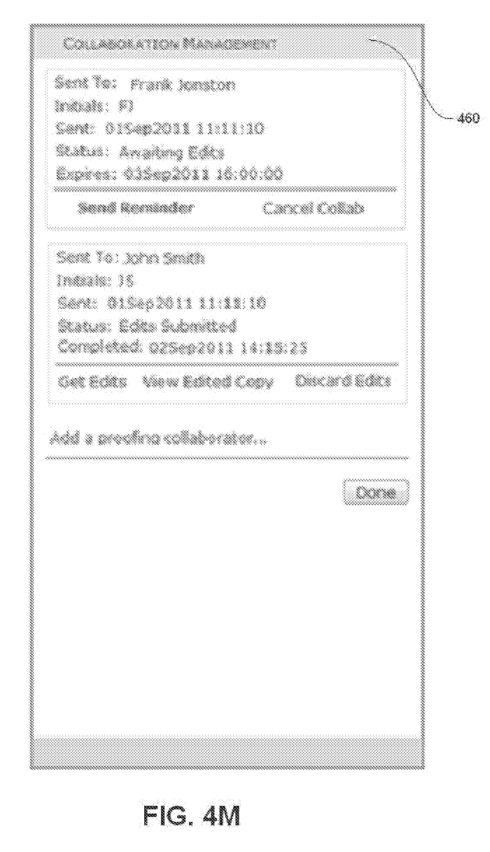

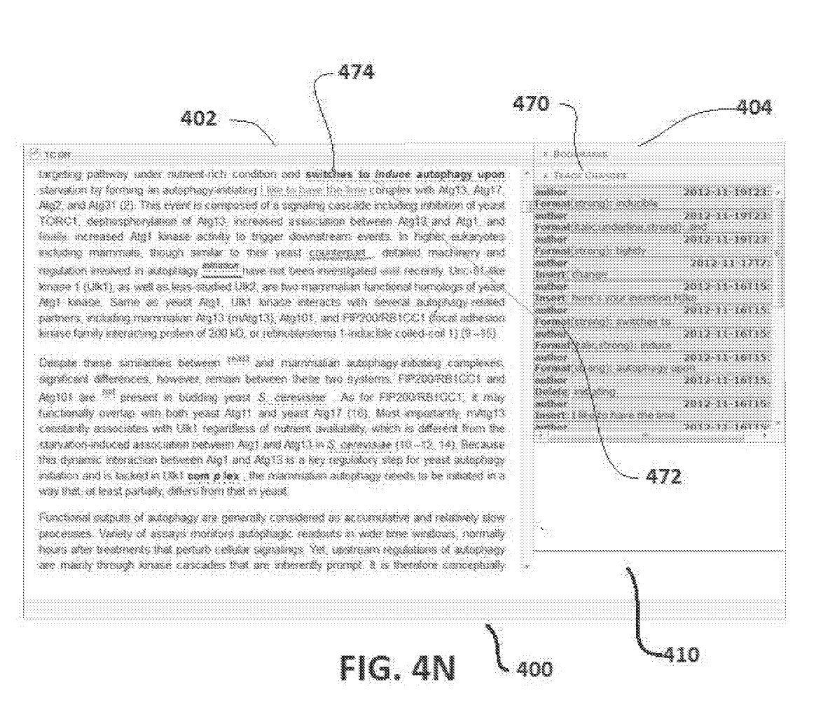

With reference to the flow diagram of FIG. 3, and as described above, HTML Proof Document 306, along with journal-specific JavaScript tools and CSS, are generated at Step 342 by CMS 300 in accordance with the inputs provided. After generation, an automated notification is sent to the author at Step 344. CMS 300 will generate such a notification message and deliver it via email or other messaging protocol, e.g. SMS text, IM or automated voice mail. An author client session will typically be initiated when the author-user signs on in response to the automated notification and is authenticated by CMS at Step 345. The user may be authenticated automatically based on the structure of a URL provided in the notification. Once the author-user is authenticated at Author Client 170, HTML Proof Document 306 is uploaded to the client at Step 346. The journal-specific JavaScript-based tools and CSS provided with Proof Document 306 configure the REGUI 400 at Step 348 in accordance with the permitted editing and proofing requirements of the journal in question, and Proof Document 306 is displayed in HTML within REGUI 400. Thereafter, at Step 350, Proof Document 306 is available for review and editing by the author-user through REGUI 400. The functionality of REGUI 400 is explained in more detail with reference to a series of exemplary screen shots provided as FIGS. 4A-N.

In one alternative embodiment, change tracking functionality 351 may be provided as a part of the review and editing at Step 350. An exemplary embodiment of a change tracking functionality is described below in connection with FIG. 4N. Change tracking functionality 351 also may be optionally provided as a part of Editorial Review at Step 354, or at another convenient location in the process flow based on particular user requirements.

When the author-user completes the review/editing session, a completion notification is sent to CMS 300 at Step 352, and CMS 300 terminates the authenticated session at Step 353. In a preferred embodiment, edits made by the author-user in REGUI 400 at Author Client 170 are communicated to CMS 300 as entered via a secure communications protocol, with the corresponding changes made to the underlying XML document 114 by CMS 300, which continuously updates HTML Proof Document 306 at REGUI 400 as the changes are made. In an alternative embodiment, editing may be applied at REGUI 400 and automatically downloaded to CMS 300 at Step 352. In a further alternative, the author-user may be prompted to save the edited document as a work in progress or to download it as complete. In general, however, the original XML document and all of its versions will be saved in CMS 300 throughout the process as a form of back-up.

In one alternative embodiment, in addition to generating HTML Proof Document 306 at Step 342, a PDF (portable document format) version of the current HTML Proof Document is also generated in parallel. The parallel PDF version may be transmitted to the author-user along with HTML Proof Document 306. By presenting a more static version of the HTML Proof Document, the parallel PDF version may be used for reference. In a further alternative embodiment, the notification message at Step 344 may include a user prompt permitting the author-user to elect to mark up the PDF version in a conventional manner. In this case, the author-user would be automatically ejected from the active editing process at Step 347 and would not utilize REGUI 400.

After the authenticated session is terminated at Step 353, the edited document undergoes editorial review at Step 354, including automatic review for changes permitted by REGUI 400. Editorial review determines at Step 355 whether the edited document is accepted. If not, further revisions consistent with the editorial review are made at CMS 300. Depending on the extent of the revisions at Step 356, the revised document may be redirected for further author-user review/editing at Step 357, in which case the process reverts to generation of a new HTML Proof Document at Step 342 (plus a new parallel PDF version in embodiments employing that alternative) and the review process is repeated as described above. If there are no changes necessary or the extent of the revisions is such that no further author-user review is necessary, the content may be finalized at Step 358 to produce Finished Content 140 at Step 360, as previously described.

Depending on the nature of the generated content, in particular its complexity, it may be desirable to implement a further, optional author review akin to the traditional “page proof” review, in which final approval was given after “galley proofs” had been reviewed and edited. One exemplary embodiment of such an optional page proof review is illustrated in FIG. 3A. In this embodiment, when content is finalized at Step 358, rather than direct it to Finished Content 140, CMS 300 generates a new “page roof” document at Step 342A. The “page proof” document may be a further HTML document or it may simply be a static PDF. When an HTML document is generated as the “page proof,” a parallel PDF version also may be provided as described in one alternative above.

When the “page proof” document is an HTML document, CMS 300 also generates new JavaScript-based tools and CSS corresponding to the journal-specific, permitted author-user functions in a page proofing environment based on Configuration Files 302, Schema 118 and the point in process flow as determined by CMS 300. The new tools and CSS would in turn display the HTML document at Author-Client in a more restricted, “page proof” REGUI 400A at Step 348A. For example, the more restricted REGUI 400A may be configured to permit review only, or in a further alternative, review and comment, but would not permit changes to the proof document, consistent with the traditional page proof. When the author-user completes the final review at Step 350A, a completion notification is sent to CMS 300 and the process proceeds generally as previously described. However, generally, an additional decision point and loop back for further author-user review (Step 357) is not included, although it could be in specific situations as dictated by journal requirements.

In a further alternative of the embodiment shown in FIG. 3A, when the “page proof” document is a static PDF document, JavaScript-based tools are not generated, Step 348 is omitted from the process flow and editorial review as Step 354 may consist of simply consideration of any comments received from the author-user.

As mentioned above, the uploaded HTML Proof Document 306 includes journal-specific configured, JavaScript-based editing tools and CSS to configure Author Client 170 to present HTML Proof Document 306 in REGUI 400. REGUI 400 presents the author-user with a welcome screen that lists the author-user's proof documents associated with interactive links. By selecting the link associated with the document to be proofed, the author-user is directed to an initial page, which may appear substantially as shown in the exemplary screen shot of FIG. 4A. The display for REGUI 400 is generally divided into a Proof Window 402 and a Navigation Window 404. Proof Window 402 presents editable text 406 of the HTML Proof Document 306. A set of word processor-like tools presented in Toolbar 408 permit direct editing of non-highly structured elements, such as text and headings, in a manner familiar to users of traditional word processing software.

However, HSEs appearing in HTML Proof Document 306 may not be directly edited. REGUI 400 does not permit direct author-user access to such elements. Instead, Navigation Window 404 presents a series of Task Widgets 410 that facilitate navigation through the document and allow for controlled editing of specific HSEs. Task Widgets 410 may be formatted as boxes, buttons, windows or drop down menus, etc. Task Widgets 410 may also include further windows and/or drop down menus, etc. to facilitate proofing tasks that are not editing functions per se such as response to author queries or the provision of comments. The provision of such widgets in addition to editing windows allows for the type of annotations familiar to authors when proofing documents but which traditionally required cumbersome mark-up of PDFs or hard copy and scanning. Navigation Window 404 may be further provided with buttons to conveniently allow edits to be saved for later consideration or directly submitted.

Bookmark Task Widget 411 provides for easy navigation to different document sections. As will be apparent from the discussion below, the task widget options presented in Navigation Window 404 may change as appropriate for the tasks permitted in specific document sections.

FIG. 4B illustrates the functionality of Author Query Widget 412. Author queries presented in this fashion permit the publisher to directly communicate questions and receive responses from the author-user in the specific context of the document to which the query is related. Author Query Tag 414 is embedded in the text as a desired location during the copy editing function. The author-user may navigate through the author queries by selecting the query number from the number bar in Author Query Widget 412. Alternatively, by directly selecting Query Tag 414 from within Proof Window 402, Author Query Widget 412 is opened to the selected query window. The query window for [AQ1] is shown in FIG. 4B. The query window for each query within Author Query Widget 412 presents query response options appropriate for the particular query, including a comment window.

Document figures are an example of an HSE with editing restricted by REGUI 400. As shown in FIGS. 4C-E, restricted figure editing is provided by Figure Widget 416. The Figure Widget includes a number bar that permits direct navigation to individual figures without scrolling through the document. Selecting the figure number from the number bar shows the figure, its label and caption. Preferably, REGUI 400 does not permit changes to the graphics of the presented figure, although in some instances, the specific journal may choose to permit such changes. In the exemplary embodiment shown in FIG. 4C, the only editing actions possible are to replace the figure by selecting the [Replace Figure] link or simple text editing of the caption within the Figure Widget window. Alternatively, the specific journal may choose to restrict editing of the figure caption as well.

Selecting the [Replace Figure] link opens Replace Figure Widget 418 as shown in FIG. 4D to permit the author-user to upload a replacement figure and provide comments. Selecting the [See Figure in Text] link from Figure Widget 416 navigates the display in Proof Window 402 to the location in the document of the active figure number as shown in FIG. 4E. Figures and their associated captions are displayed in a Figure Box 420 to distinguish them from editable text 406. The Figure Widget window corresponding to a particular figure number also may be made active by selecting a corresponding Figure Number Link 422 from within the editable text 406 displayed in Proof Window 402. While text surrounding Figure Number Link 422 may be edited, REGUI 400 prevents any changes to the figure number element itself. As shown in Figure Box 420 and Figure Widget 416, a banner may be displayed to advise when a figure has been replaced. Alternatively, the figure may be presented in an editable window that would permit controlled editing such as annotations or mark ups.

FIG. 4F illustrates an author commenting feature of REGUI 400. Navigation Window 404 includes Comment Widget 424. To add a comment to editable text 406, the author-user locates the cursor within the text in Proof Window 402 and selects an add comment button, which may be located in Toolbar 408 or at another convenient location, to add a Comment Tag 426 to the editable text 406 at the cursor location, and also open Comment Widget 424. A window is provided within Comment Widget 424 for the comments as shown. Comments are automatically numbered and displayed sequentially in tabs across a number bar in the Comment Widget as additional comments are added. If an alternative “page proof” process is included in CMS 300, as described above in connection with FIG. 3A, one alternative is to include an author-user comment function in the more restricted REGUI 400A. Such a comment function may be implemented as described above in connection with Comment Widget 424.

Citations are another type of HSE with restricted editing provided by REGUI 400. Citations may include, for example, internal cites to tables, figures or other graphics included within the document. FIGS. 4G and 4H illustrate features of REGUI 400 for restricted editing of these elements. As shown in FIG. 4G, Insert Figure Citation Widget 428 permits the insertion of figure citations into editable text 406. Insert Table Citation Widget 432, shown in FIG. 4H works in substantially the same way. These tools permit changing of graphics citations such as citation 430 (which is also a Figure Number Link as referred to above at 422), or inserting a citation at a new location in editable text 406 by locating the cursor. A pull-down window within Insert Citation Widget 428 allows the author-user to select the type of citation to be edited and the selection causes the correct window to open. For example, in FIG. 4G, the “Fig.” citation is selected and the Insert Figure Citation Widget 428 remains open. If the user instead selected “Table,” from the available types, Insert Table Citation Widget 432 as shown in FIG. 4H would instead open. In an alternative embodiment, the main toolbar allows the author user to select the type of citation to add. In this case, the drop down window may provide only for selecting the label style, e.g., “Fig.” vs. “Figure”. The figure (or table) number to be inserted is provided in the right-hand box by the author-user. In one exemplary embodiment, insertion of figure or table citations is limited to existing figures and tables, or other existing graphics as listed, by REGUI 400. The [Insert Citation] button within Widget 428 completes the citation insertion.

References (third party publications referred to in the document being edited) and citations to references may be among the most structured HSEs. For this reason, a number of separate windows, as shown in FIGS. 4I-4L are included within REGUI 400 for editing references and their citations in a sufficiently restricted manner. Update Reference Citation Widget 434, shown in FIG. 4I, permits the author-user to edit the citation references, e.g. reference citation 436. Reference citations may also be provided in the form of an active link that permits navigation directly to the reference list as discussed below. The author-user highlights the reference citation to be updated and then selects the correct reference from drop down list 438 as shown in FIG. 4J. Only those references already listed in the document may be selected from with the Update Reference Citation feature.

If multiple references are to be listed in a citation, as in citation 436, then additional drop down menus 438 can be added to the Update Reference Citation Widget 434 by selecting the Add Citation Button 440. This provides additional drop down lists so additional references can be listed in a citation. Alternatively, a new drop down list will automatically be generated when the existing ones are all used, obviating the need for Button 440. In order to update a citation, the author-user highlights the subject citation within Proof Window 402, e.g. citation 436, and then selects an existing reference from the drop down menus as explained. REGUI 400 automatically updates the selected citation with the new citation number and automatically formats the updated citation to specific journal style. For example, reference citations in different journals frequently are presented in different formats, such as in a numbered format or an “author-date” format. The number of sub-variations within these two general format classes may be as many as the number of journals themselves. However, because REGUI 400 is specifically configured based on journal-specific configuration files 302 for the journal style corresponding to the article under editing in accordance with the REP, the formatting responsibilities for these elements are removed from the author and enforced by the system. For example, depending on the journal-specific REP, REGUI 400 may only permit existing reference citations as provided during the original copy editing process to be updated. Alternatively, REGUI 400 could be configured to permit the addition of new reference citations at new locations within the document as long as such changes met the requirements of the REP.

Because of the complex structure of reference elements, a more detailed user interface is provided to address the various elements and maintain their structure. Also, the content of HTML Proof Document 306 in the references section is not text editable even though it is displayed in Proof Window 402. Instead, as shown in FIG. 4K, an Edit Reference Link 446 is provided for each reference entry in the references section of the document. In order to edit a reference, the author-user selects the Edit Reference link, which opens Update Reference Widget 442. Update Reference Widget 442 includes boxes for each field of a reference entry. These field boxes are automatically configured for the specific journal and the type of reference by selecting the reference type from drop down menu reference type menu 444, with reference type “Journal” being illustrated in FIG. 4K. Permitting changes and data entry only in specifically limited fields enforces the structured nature of the reference element on a journal-specific basis as previously described. To the extent the author-user needs to confirm information regarding a reference, Web Search Link 448 automatically generates a web search for references matching information provided in the listed reference entry. In one exemplary embodiment, as illustrated in FIG. 4K, Web Search Link 448 is configured as a PubMed lookup function (PubMed is a service of the National Library of Medicine that includes access to online journals: http://www.ncbi.nlm.nih.gov/pubmed.) Other specifically configured web search functions may be provided as particularly suited to journal-specific applications.

A successful web search using Web Search Link 448 returns the results in a pop-up window 450, as shown in FIG. 4L. The search results are automatically configured by REGUI 400. The author-user simply selects the desired search result and the relevant fields of the Update Reference Widget 442 are correctly populated. When a new reference is needed, as opposed to updating a reference, the Insert Reference Widget 452 is selected (FIG. 4L). Insert Reference Widget 452 includes the same fields as Update Reference Widget 442, but instead of updating an existing reference the new reference is automatically numbered and added to the end of the reference section when the Insert Reference button is selected.

In addition to author commenting (FIG. 4D), a collaboration feature may be included. In one implementation, Collaborator Widget 460, as shown in FIG. 4M, may be provided at one side of the REGUI 400 as a pull down window, for example in Navigation Window 404. Collaborator Widget 460 may provide options for various permissions to identified collaborators, such as comment only, text edit only, text edit and query response, or full proxy. The collaborators may be selected from a preset menu configured as part of the Collaborator Widget, based on information previously provided by the author or journal and enforced through REGUI 400. Alternatively, the author may designate collaborators such as by email invitation.

In another aspect of the invention, embodiments may alternatively include change tracking functionality 351 as indicated above in connection with FIG. 3. Change tracking functionality 351 provides a relatively high level of granularity in identifying each individual change made and its relationship with other changes. Change tracking in XML documents is traditionally limited by the normalization of the XML code. Normalization is well-known to be desirable in XML coding because it produced more uniform coding, with reduced redundancy and complexity of the code. However, normalization presents special challenges for change tracking because normalized XML code may present less information for determining relationships among nested changes, particularly when such changes are made at different times and/or by different authors independently collaborating on a document. These challenges are exacerbated when multiple authors or editors subsequently and independently seek to accept or reject various combinations of the previously entered changes. Without complete information on the relationship of nested changes, some combinations of accepting and rejecting the changes may result in breaking of the XML code.

The change tracking functionality begins with changes being made to a document via REGUI 400 at the remote Author Client 170. In one exemplary embodiment of the invention, the changes are tagged via JavaScript to add elements, processing instructions, comments, and/or attributes associated with each change. Examples of attributes that may be assigned include [author of change], [time of change], [date of change], [grouped (nested) relationship of changes] and [accept/reject status]. An example of tagging with an “insertion” element and attributes of author and time is shown in the following Table I.

TABLE I

| | |
|---|---|
| Original Content: | This is the text. |
| Changed Content: | This is the additional text |
| Tagged Change: | This is <insertion author=“aa” |
| | time=“3489392848”>additional |
| | </insertion> text. |

During the editing process, typically occurring at Author Client 170, a “change schema” may be applied by CMS 300 for validation of the change containing version of the document. In an exemplary embodiment, the change schema may be a superset of a base schema, e.g., a standard schema such as the JATS 1.0 Journal Publishing Tag Set. The superset will include additional rules governing the change elements and attributes, etc. as discussed above. Once the document is finalized, with all changes resolved by acceptance or rejection, that standard schema is applied in a conventional manner to validate the final XML coding.

In order to make change tracking more effective, embodiments of the invention employ a “denormalizing” process as part of the change tracking function in order to individually code each separate change occurrence. The denormalizing process assigns independent and distinct tagging elements representing each individual aspect of each change made. The following Table II contains a simplified example to illustrate this aspect of the invention further based on hypothetical formatting change to text content consisting of “This is the text.” With the XML code denormalized as shown, each change can be tracked on a character-by-character basis, thus providing greater flexibility in the editing and proofing processes.

TABLE II

| Content | | Corresponding XML Code |
|---|---|---|
| 1 | The original text before change: | |
| | This is the text. | <text>This is the text.</text> |
| 2 | Changed text with “is the text” italicized, but only | |
| | “the” additionally bolded and conventional, | |
| | normalized XML coding of the change: | |
| | This is [symbol] text. | <text>This <i>is <B>the </B>text</i>.</text> |
| 3 | Same changed text, but with denormalized XML coding of the | |
| | change in accordance with embodiments of the present | |
| | invention: | |
| | This is [symbol] text. | <text>This <i>is </i><i><B>the </B></i> |
| | | <i>text</i>.</text> |

“Denormalizing” is thus a process of introducing intentionally redundant tagging by defining a set of elements that will be closed and reopened whenever a nested element of the same set is encountered. In the resulting XML code, the only time the elements within the set can be in a parent-child or ancestor-descendent relationship is when they have the same text node as their only descendent that is a text node. That is, all ancestor elements of a particular text node that are in this set will have no intervening text nodes.

However, with nested changes as described above, anomalies may be introduced into the document if the acceptance and rejection of changes is not controlled. For example, consider a simplified situation in which a first change to a text section within a larger document involves the addition of new text, but a second change deletes the text section entirely, an editor accepting and rejecting changes may inadvertently accept both the insertion and deletion unless hierarchical control is imposed. Such hierarchical control may involve the identification of dependent relationships among nested changes and enforcing the dependencies from outer to inner changes. In one embodiment, dependencies may be enforced through the use of a database that specifies permitted actions. An example of such a database may comprise an accept/reject table that specifies permitted actions in response to initial actions with respect to nested outer and inner changes by imposing an effect on an inner change in response to a specific action on a corresponding inner change. Table III below provides one example of how such an accept/reject table may be logically presented.

TABLE III
Accept/Reject Table

| | | Action | |
|---|---|---|---|
| Outer Change | Inner Change | on Outer | Effect on Inner |
| Insertion | Insertion | Accept | Allow Accept or Reject |
| Insertion | Insertion | Reject | Force Reject |
| Insertion | Deletion | Accept | Allow Accept or Reject |
| Insertion | Deletion | Reject | Force Accept |
| Deletion | Insertion | Accept | Force Reject |
| Deletion | Insertion | Reject | Allow Accept or Reject |
| Deletion | Deletion | Accept | Force Accept |
| Deletion | Deletion | Reject | Allow Accept or Reject |
| Insertion | Formatting | Accept | Allow Accept or Reject |
| Insertion | Formatting | Reject | Remove Text |
| Deletion | Formatting | Accept | Remove Text |
| Deletion | Formatting | Reject | Allow Accept or Reject |
| Formatting* | Ins or Del | Accept or | No Effect |
| | | Reject | |
| Formatting | Unformatting | Accept | Allow Accept or Reject |
| Formatting | Unformatting | Reject | Force Accept |

In one embodiment, to utilize the change tracking feature, the editor or author selects the Track Changes Widget 470 from the navigation window 404 as shown in FIG. 4N. When the Track Changes Widget 470 is selected, the text is presented in Proof Window 402 with changes identified as, for example, at change 474. Additionally, a listing of changes contained within Proof Window 402 is presented in track changes Widget 470. A line or other correlating feature may be used to associate the highlighted change in Proof Window 402 with the listed change in Navigation Window 404, such as, for example, shown at listing 472. The user may accept or reject changes presented in widget 470 by functionality provided through the user interface, such as right clicking to present a drop down menu with options to accept or reject selected changes.

As previously discussed, exemplarily locations for utilization of the change tracking function in the overall process flow include as branches off Realtime Review 350 or Editorial Review 354 among others. When the user selects the Track Changes Widget 470, the system initiates change tracking functionality 351 by denormalizing the selected document as discussed above. Denormalizing may be accomplished by the use of an XSLT stylesheet executed at CMS 300. Persons having ordinary skill in the art may develop appropriate XSLT stylesheets to accomplish the denormalization as described herein. In one exemplary embodiment, denormalization is applied to all elements that represent insertions and deletions, i.e., content changes, as well as all elements representing formatting (bold, italic, etc.). Other than formatting, original content is not denormalized in this example. In the case of formatting elements, denormalization is applied regardless of whether the formatting elements are the result of changes or were in the original content. Elements to be denormalized may be identified in the processing by a number of factors. For example, in some cases, the formatting elements may be established as custom elements that are uniquely identified by the system or in other cases elements representing changes include attributes indicative of a change, such as author of the change, the time of the change, etc.

After denormalization, the document and tracked changes are presented in REGUI as shown, for example in FIG. 4N. When the user terminates the change tracking function, CMS 300 automatically “re-normalizes” the XML coding in accordance with the appropriate schema and for subsequent processing according to the process flow, examples of which are described above with reference to FIGS. 3 and 3A. In some embodiments of the invention, it may be desirable to include change tracking functionality within the collaboration function, such as implemented through Collaborator Widget 460 shown in FIG. 4M. In this case it may be further desirable to control acceptance or rejection of changes by collaborators who are not the primary author. Thus, when change tracking functionality 351 is initiated through Collaborator Widget 460, one of the collaborator's permissions as related to change tracking may be limited to viewing the tracked changes, but not accepting or rejecting changes.

It is to be noted that any one or more of the aspects and embodiments described herein may be conveniently implemented using one or more machines (e.g., one or more computing devices that are utilized as a user computing device or one or more server devices) programmed according to the teachings of the present specification. Appropriate software coding can readily be prepared by skilled programmers based on the teachings of the present disclosure. Aspects and implementations discussed above employing software and/or software modules may also include appropriate hardware for assisting in the implementation of the machine executable instructions of the software and/or software module.

Such software may be a computer program that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk (e.g., a conventional floppy disk, a hard drive disk), an optical disk (e.g., a compact disk “CD”, such as a readable, writeable, and/or re-writable CD; a digital video disk “DVD”, such as a readable, writeable, and/or rewritable DVD), a magneto-optical disk, a read-only memory “ROM” device, a random access memory “RAM” device, a magnetic card, an optical card, a solid-state memory device (e.g., a flash memory), an EPROM, an EEPROM, and any combinations thereof. A machine-readable medium, as used herein, is intended to include a single medium as well as a collection of physically separate media, such as, for example, a collection of compact disks or one or more hard disk drives in combination with a computer memory. As used herein, a machine-readable storage medium does not include a signal.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

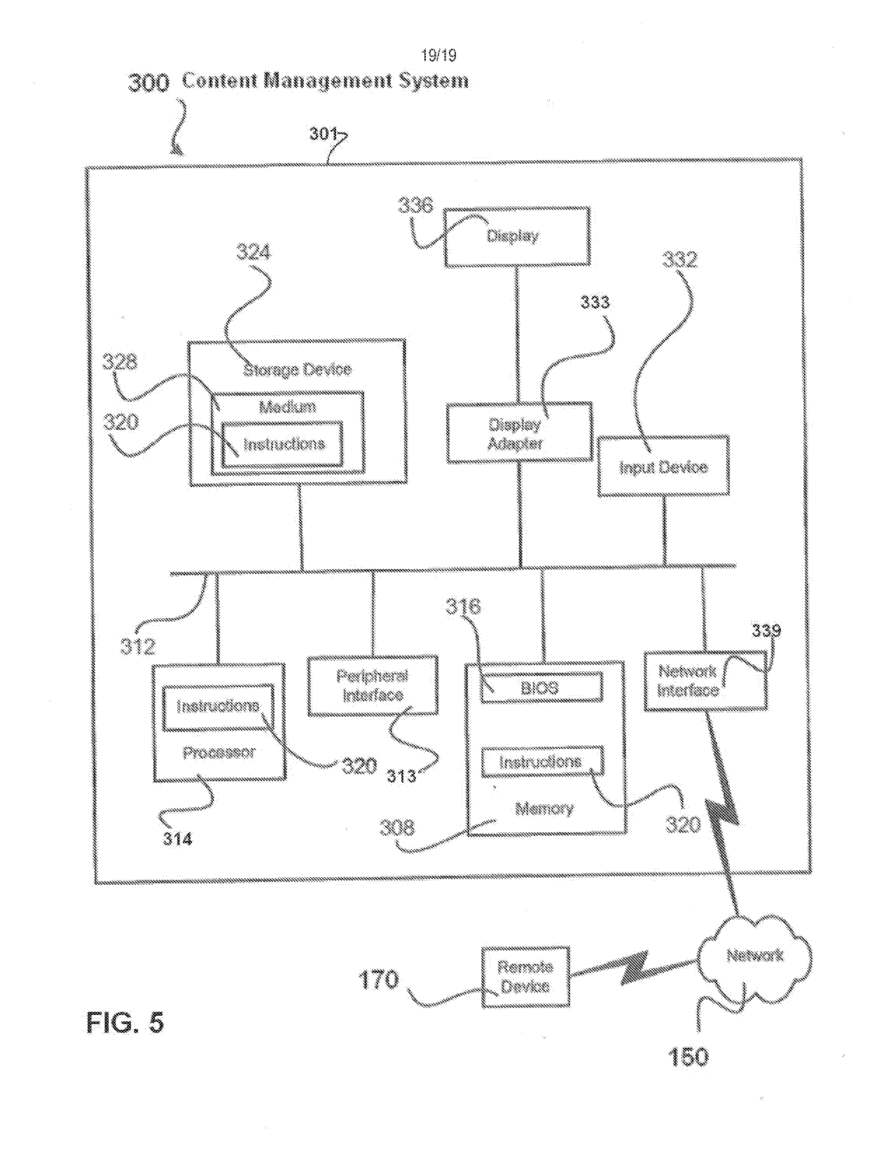

FIG. 5 shows a diagrammatic representation of one embodiment of a computing device 301 in the exemplary form of CMS 300 within which a set of instructions for causing the system to communicate with and specifically configure Author Client 170 in the prescribed manner in accordance with the functionality described herein above. It is also contemplated that multiple computing devices may be utilized to implement a specially configured set of instructions for causing CMS 300 to perform any one or more of the aspects and/or methodologies of the present disclosure.

In this exemplary embodiment, CMS 300 includes a processor 314 and a memory 308 that communicate with each other, and with other components, via a bus 312. Bus 312 may include any of several types of bus structures including, but not limited to, a memory bus, a memory controller, a peripheral bus, a local bus, and any combinations thereof, using any of a variety of bus architectures.

Memory 308 may include various components (e.g., machine readable media) including, but not limited to, a random access memory component (e.g., a static RAM “SRAM”, a dynamic RAM “DRAM”, etc.), a read only component, and any combinations thereof. In one example, a basic input/output system 316 (BIOS), including basic routines that help to transfer information between elements within CMS 300, such as during start-up, may be stored in memory 308. Memory 308 may also include instructions (e.g., software) 320 embodying any one or more of the aspects and/or methodologies of the present disclosure. In another example, memory 308 may further include any number of program modules including, but not limited to, an operating system, one or more application programs, other program modules, program data, and any combinations thereof.

CMS 300 may also include a machine readable storage device 324. Machine readable storage device 324 may be connected to bus 312 by an appropriate interface (not shown). Example interfaces include, but are not limited to, SCSI, advanced technology attachment (ATA), serial ATA, universal serial bus (USB), IEEE 1294 (FIREWIRE), and any combinations thereof. In one example, machine readable storage device 324 (or one or more components thereof) may be removably interfaced with CMS 300 (e.g., via an external port connector (not shown)). Particularly, machine readable storage device 324 and an associated machine-readable medium 328 may provide nonvolatile and/or volatile storage of machine-readable instructions, data structures, program modules, and/or other data for CMS 300. In one example, software 320 may reside, completely or partially, within machine-readable medium 328. In another example, software 320 may reside, completely or partially, within processor 314.

CMS 300 may also include an input device 332. In one example, a user of CMS 300 may enter commands and/or other information into the CMS via input device 332. Examples of an input device 332 include, but are not limited to, an alpha-numeric input device (e.g., a keyboard), a pointing device, an audio input device (e.g., a microphone, a voice response system, etc.), a cursor control device (e.g., a mouse), a touchpad, an optical scanner, touch-screen, and any combinations thereof. Input device 332 may be interfaced to bus 312 via any of a variety of interfaces (not shown) including, but not limited to, a serial interface, a parallel interface, a USB interface, a FIREWIRE interface, a direct interface to bus 312, and any combinations thereof. Input device 332 may include a touch screen interface that may be a part of or separate from display 336, discussed further below. Input device 332 may be utilized as a user selection device for selecting one or more graphical representations in a graphical interface as described above.

A user may also input commands and/or other information to CMS 300 via storage device 324 (e.g., a removable disk drive, a flash drive, etc.) and/or network interface device 339. A network interface device 339 may be utilized for connecting CMS 300 to one or more of a variety of networks, such as network 150, and one or more remote devices, such as Author Clients 170, connected thereto. Examples of a network interface device 339 include, but are not limited to, a network interface card (e.g., a mobile network interface card, a LAN card), a modem, and any combination thereof. Examples of a network 150 include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. Network 150 may employ a wired and/or a wireless mode of communication. In general, any network topology may be used. Information (e.g., data, software 320, etc.) may be communicated to and/or from CMS 300 via network interface device 339.

CMS 300 may further include a video display adapter 333 for communicating a displayable image to a display device, such as display device 336. Examples of a display device include, but are not limited to, a liquid crystal display (LCD), a cathode ray tube (CRT), a plasma display, a light emitting diode (LED) display, and any combinations thereof. Display adapter 333 and display device 336 may be utilized in combination with processor 314 to provide a graphical representation of a utility resource, a location of a land parcel, and/or a location of an easement to a user. In addition to a display device, CMS 300 may include one or more other peripheral output devices including, but not limited to, an audio speaker, a printer, and any combinations thereof. Such peripheral output devices may be connected to bus 312 via a peripheral interface 313. Examples of a peripheral interface include, but are not limited to, a serial port, a USB connection, a FIREWIRE connection, a parallel connection, and any combinations

While the invention has been described in connection with what are presently considered to be the most practical and preferred embodiments, it is to be understood that the invention is not limited to the disclosed embodiments and alternatives as set forth above, but on the contrary is intended to cover various modifications and equivalent arrangements included within the scope of the following claims.

In addition to CMS 300, as will be appreciated by persons of ordinary skill in the art, the hardware configuration of other processing centers in embodiments of the present invention may be configured substantially as described above for CMS 300. In particular, both graphics processing and content delivery 210, as well as Author Client 170, may be configured generally in accordance with the system shown in FIG. 5, with appropriate modifications to the execution and programming as described herein and as will be understood by persons skilled in the art. For example, when Author Client 170 is based on a computing device such as computing device 301, then journal-specific configuration files 304, when received through network interface 339, will instruct processor 314 to specifically configure display 336 and input device 332 as REGUI 400 such that the processor will be restricted to only modify XML Proof Document 306 in accordance with REGUI 400 permitted boundaries while stored by the computing device in memory 308 or other storage device 324. In this case, Author Client 170 performs as a specifically configured editing machine in accordance with instructions communicated through network 150 via journal-specific configuration files.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A computer-implemented method for restricted editing of documents containing highly structured elements (HSEs) provided across a network, comprising:
initiating an authenticated editing session at a client to permit user editing of a remotely provided document containing at least one HSE, the document being correlated to the authenticated editing session;
receiving the document at said client from a remote associated server system via said network;
displaying at the client a first display interface presenting said document and permitting direct editing of non-HSE portions of said document;
displaying at the client at least one second display interface presenting said at least one HSE for editing in accordance with a restricted editing protocol (REP) corresponding to said document;
providing in said first display interface a first set of tools suitable for direct user editing of said non-HSE portions within said first display interface;
providing in said second display interface at least one second set of restricted editing tools configured to permit user editing of a presented HSE in accordance with the REP, wherein said at least one second set of restricted editing tools is specifically configured for a corresponding HSE;
editing the document using said first and second sets of tools in accordance with the REP to create an edited document;
transmitting the edited document to the remote associated server via said network; and
terminating the authenticated editing session after said editing.

2. The method of claim 1, wherein said REP contains unique formatting requirements for said document.

3. The method of claim 2, wherein said unique formatting requirements correspond to a specific publication that is to contain said document.

4. The method of claim 1, wherein said displaying of said first and second display interfaces comprises receiving instructions for establishing a restricted editing graphical user interface (REGUI) at said client, and configuring the REGUI to permit editing in accordance with the REP.

5. The method of claim 4, wherein said instructions are associated with a specific journal style.

6. The method of claim 4, wherein:
said remotely provided document comprises an HTML document; and
said first and second display interfaces are presented in a single graphical user interface at said client for displaying said HTML document.

7. The method of claim 6, wherein said instructions comprise JavaScript-based tools within said HTML document.

8. The method of claim 6, wherein said first display interface comprises a proof window presenting direct user editable text of the proof document, and said second display interface comprises a navigation window presenting plural links for initiating controlled editing of specific HSEs.

9. The method of claim 8, wherein said plural links are each associated with a specific task widget.

10. The method of claim 1, wherein:
one said second display interface is configured to present an author query widget providing communication with a user at the client with respect to unique locations within the user editable text, said widget presenting a form for presenting and responding to author queries; and
said first display interface is configured to display a non-editable link within the user editable text at each unique author query location.

11. The method of claim 1, wherein said REP includes specific formatting requirements for figures within the document and one said second display interface is configured to display a figure widget, the figure widget presenting a form for editing figures in accordance with said REP.

12. The method of claim 11, wherein said figure widget is configured to present a replace figure widget, the replace figure widget presenting a form for uploading a replacement figure at said client.

13. The method of claim 11, wherein selecting a figure link within said figure widget navigates the document displayed in said first display interface to a location of the selected figure with the selected figure HSE displayed within a figure box within said first display interface in accordance with said REP.

14. The method of claim 1, wherein:
one said second display interface is configured to present a comment widget providing for insertion of user comments at unique locations within the user editable text, said comment widget presenting a form for inserting a comment; and
said first display interface is configured to display a non-editable link to said comment within the user editable text at each unique comment location.

15. The method of claim 1, wherein said REP includes specific formatting requirements for figure citations within the document and one said second display interface is configured to display a figure citation widget, the figure citation widget presenting a form for editing figures citations in accordance with said REP.

16. The method of claim 1, wherein said REP includes specific formatting requirements for table citations within the document and one said second display interface is configured to display a table citation widget, the table citation widget presenting a form for editing table citations in accordance with said REP.

17. The method of claim 1, wherein said REP includes specific formatting requirements for reference citations within the document and one said second display interface is configured to display a reference citation widget, the reference citation widget presenting a form for editing reference citations in accordance with said REP.

18. The method of claim 17, wherein said reference citation widget includes a selectable menu with navigable links to references cited within the document.

19. The method of claim 18, wherein reference citation editing is restricted to removing from, relocating within or inserting into the user editable text a reference citation included in said selectable menu.

20. The method of claim 17, wherein said first display interface is configured to display a references section presenting reference citations in non-user editable form with associated selectable links configured to open an update reference widget, said update reference widget presenting a form for updating reference citations in accordance with a user selectable reference type and said REP.

21. The method of claim 20, wherein said update reference widget includes a user selectable web search link configured to automatically conduct a web-based search for references based on user entered information contained within the update reference widget form and populate said form based on user selectable results of said search.

22. The method of claim 1, wherein said REP includes specific requirements for permitted access by collaborators and one said second display interface is configured to display a collaborator widget, the collaborator widget presenting selectable collaborator permissions, wherein selection of a collaborator permission initiates remote collaboration in accordance with said REP.

23. The method of claim 1, wherein:
one said second display interface is configured to present a track changes widget providing for navigation through and accepting or rejecting changes contained within the document, said track changes widget presenting a listing of changes presented in the document; and
said first display interface is configured to display document text with identified changes correlated to changes in said listing of changes.

24. A computer-implemented method for restricted remote editing across a network of documents containing highly structured elements (HSEs), comprising:
receiving authentication credentials at a server from a remote client;
initiating an authenticated remote client editing session based on authentication of said credentials at said server;
identifying a document containing HSEs corresponding to said authenticated credentials;
transmitting instructions to said remote client for configuring the remote client as a restricted editing graphical user interface (REGUI), said set of instructions comprising instructions for:
configuring the remote client to display a first display interface for presenting said document and permitting direct editing of non-HSE portions of said document,
configuring the remote client to display a second display interface for presenting at least one HSE for editing in accordance with a restricted editing protocol (REP),
providing in said first display interface a first set of tools suitable for direct user editing of said non-HSE portions within said first display interface,
providing in said second display interface at least one second set of restricted editing tools configured to permit user editing of a presented HSE in accordance with the REP, wherein said at least one second set of restricted editing tools is specifically configured for a corresponding HSE, and
transmitting the user entered edits from the remote client to the server via said network;
transmitting the identified document to the remote client for display and editing in accordance with the REP;
receiving the user entered edits from the remote client; and
terminating the authenticated remote client editing session upon receipt of a completion notification.

25. The method of claim 24, wherein:
said transmitting instructions and transmitting the identified document comprise transmitting a proof document; and
said method further comprises (a) generating the proof document including instructions for displaying elements including HSEs at the remote client and instructions for editing said elements in accordance with the REP, and (b) transmitting a notification to the remote user indicating the proof document is available.

26. The method of claim 25, wherein said generating the proof document comprises:
accessing an XML document associated with a specific journal for publication in accordance with a journal style corresponding to said specific journal;
identifying a schema and configuration files corresponding to the specific journal style, wherein said configuration files determine the REP; and
generating an HTML document from said XML document in accordance with said schema, said HTML document including said instructions for editing as determined by said configuration files, the HTML document comprising said proof document.

27. The method of claim 26, further comprising identifying content associated with said XML document and incorporating said content into the generated HTML document consistent with the schema.

28. The method of claim 26, wherein said identifying a schema and configuration files comprises selecting associated schema and configuration files corresponding to the specific journal style from among a plurality of stored schema and configuration files associated with plural journal styles.

29. The method of claim 24, further comprising identifying and selecting the REP, wherein said REP is selected from a plurality of REPs.

30. The method of claim 29, wherein each said REP contains unique formatting requirements corresponding to a specific journal style.

31. The method of claim 24, wherein said instructions for configuring the remote client display to display first and second display interfaces comprise instructions for presenting said displays in a single graphical user interface at said client.

32. The method of claim 24, wherein said initiating step comprises a step of determining a specific journal corresponding to the received credentials.

33. The method of claim 26, further comprising further generating said document in a PDF format, and wherein said transmitting the document comprises additionally transmitting the document in PDF format.

34. The method of claim 24, wherein:
the identified document comprises a document for publication in a specific journal having a specific journal style; and
the REP includes formatting requirements for enforcing the specific journal style including restrictions on editing of HSEs.

35. The method of claim 24, wherein said first display interface comprises a proof window presenting direct user editable text of the proof document, and said second display interface comprises a navigation window presenting plural links for initiating controlled editing of specific HSEs.

36. The method of claim 35, wherein said plural links are each associated with a specific task widget.

37. The method of claim 24, wherein:
said instructions for configuring the second display interface include instructions to present an author query widget providing communication with a user at the client with respect to unique locations within the user editable text, said widget presenting a form for presenting and responding to author queries; and
said instructions for configuring the first display interface include instructions to display a non-editable link within the user editable text at each unique author query location.

38. The method of claim 24, wherein said REP includes specific formatting requirements for figures within the document and said instructions to configure the second display interface include instructions to display a figure widget, the figure widget presenting a form for editing figures in accordance with said REP.

39. The method of claim 38, wherein said figure widget is configured to present a replace figure widget, the replace figure widget presenting a form for uploading a replacement figure at said client.

40. The method of claim 38, wherein said figure widget is configured to present a figure link within said figure widget, the figure link being configured to navigate the document displayed in said first display interface to a location of the selected figure with the selected figure HSE displayed within a figure box within said first display interface in accordance with said REP.

41. The method of claim 24, wherein:
said instructions to configure said second display interface include instructions to present a comment widget providing for insertion of user comments at unique locations within the user editable text, said comment widget presenting a form for inserting a comment; and
said instructions to configure said first display interface include instructions to display a non-editable link to said comment within the user editable text at each unique comment location.

42. The method of claim 24, wherein said REP includes specific formatting requirements for figure citations within the document and said instructions to configure the second display interface include instructions to display a figure citation widget, the figure citation widget presenting a form for editing figures citations in accordance with said REP.

43. The method of claim 24, wherein said REP includes specific formatting requirements for table citations within the document and said instructions to configure the second display interface include instructions to display a table citation widget, the table citation widget presenting a form for editing table citations in accordance with said REP.

44. The method of claim 24, wherein said REP includes specific formatting requirements for reference citations within the document and said instructions to configure the second display interface include instructions to display a reference citation widget, the reference citation widget presenting a form for editing reference citations in accordance with said REP.

45. The method of claim 44, wherein said reference citation widget includes a selectable menu with navigable links to references cited within the document.

46. The method of claim 45, wherein reference citation editing is restricted to removing from, relocating within or inserting into the user editable text a reference citation included in said selectable menu.

47. The method of claim 44, wherein said instructions to configure the first display interface include instructions to display a references section presenting reference citations in non-user editable form with associated selectable links configured to open an update reference widget, said update reference widget presenting a form for updating reference citations in accordance with a user selectable reference type and said REP.

48. The method of claim 47, wherein said update reference widget includes a user selectable web search link configured to automatically conduct a web-based search for references based on user entered information contained within the update reference widget form and populate said form based on user selectable results of said search.

49. The method of claim 24, wherein said REP includes specific requirements for permitted access by collaborators and said instructions to configure the second display interface include instructions to display a collaborator widget, the collaborator widget presenting selectable collaborator permissions, wherein selection of a collaborator permission initiates remote collaboration in accordance with said REP.

50. The method of claim 24, wherein
said receiving user entered edits comprises receiving information representing one or more changes to said document, wherein said information comprises at least one content change and at least one attribute value associated with each said content change; and
said method further comprises:
processing said document in accordance with the received content changes while maintaining the association between each said content change and said at least one associated attribute value, wherein said processing comprises tagging said document in accordance with an associated change schema for said document to produce a changed document reflecting said content changes;
receiving a change tracking request with respect to the changed file;
generating a change tracked version of the changed document in response to said change tracking request, wherein the tracked change document represents the content changes in a denormalized tagging format;
transmitting said change tracked version to the remote client;
receiving at least one of accept or reject instructions from the remote client with respect to said content changes;
accepting or rejecting content changes in accordance with said received accept or reject instructions to produce a finalized document;
controlling said accepting or rejecting of content changes with respect to least one of nested or grouped changes; and
validating the finalized file in accordance with a base schema.

51. The method of claim 50, wherein said controlling comprises identifying dependent relationships among nested changes and enforcing said relationships in accordance with a database specifying permitted accept and reject actions in response to initial actions with respect to nested outer and inner changes by imposing an effect on an inner change in response to a specific action on a corresponding inner change.

52. A network-based system for restricted remote editing of document containing highly structured elements (HSEs), comprising:
at least one storage medium configured to store at least one document containing at least one HSE and instructions to configure said system for restricted remote editing of said at least one document, said instructions comprising instructions for—
a) authenticating user credentials received from the remote client,
b) retrieving a document from the storage device corresponding to the authenticated credentials,
c) determining a restricted editing protocol (REP) corresponding to the retrieved document,
d) transmitting REP instructions to said remote client for configuring the remote client as a restricted editing graphical user interface (REGUI) corresponding to the determined REP, said REP instructions comprising instructions for—
configuring the remote client to display a first display interface for presenting said document and permitting direct editing of non-HSE portions of said document,
configuring the remote client to display a second display interface for presenting at least one HSE for editing in accordance with said REP,
providing in said first display interface a first set of tools suitable for direct user editing of said non-HSE portions within said first display interface,
providing in said second display interface at least one second set of restricted editing tools configured to permit user editing of a presented HSE in accordance with the REP, wherein said at least one second set of restricted editing tools is specifically configured for a corresponding HSE, and
transmitting the user edited document to an associated server system via said network, and
e) transmitting the retrieved document to the remote client for display and editing in accordance with said REP;
a network interface configured for communication with a remote client through which user editing of the document is to be performed; and
a processor communicating with said at least one storage medium and network interface, the processor configured to execute the instructions.

53. The network-based system of claim 52, wherein:
said instructions for transmitting REP instructions and transmitting the retrieved document comprise transmitting a proof document; and
said instructions further comprise instructions for (a) generating the proof document including instructions for displaying elements including HSEs at the remote client and instructions for editing said elements in accordance with the REP, and (b) transmitting a notification to the remote user indicating the proof document is available.

54. The network-based system of claim 53, wherein said instructions generating the proof document comprise instructions for:
accessing an XML document associated with a specific journal for publication in accordance with a journal style corresponding to said specific journal;
identifying a schema and configuration files corresponding to the specific journal style, wherein said configuration files determine the REP; and
generating an HTML document from said XML document, said HTML document including said instructions for editing as determined by said configuration files, the HTML document comprising said proof document.

55. The network-based system of claim 54, wherein said instructions further comprise instructions identifying content associated with said XML document and incorporating said content into the generated HTML document consistent with the schema.

56. The network-based system of claim 54, wherein said instructions for identifying a schema and configuration files comprise instructions for selecting associated schema and configuration files corresponding to the specific journal style from among a plurality of stored schema and configuration files associated with plural journal styles.

57. The network-based system of claim 52, wherein said instructions further comprise instructions for identifying and selecting the REP, wherein said REP is selected from a plurality of REPs.

58. The network-based system of claim 57, wherein each said REP contains unique formatting requirements corresponding to a specific journal style.

59. The network-based system of claim 52, wherein said instructions for configuring the remote client display to display first and second display interfaces comprise instructions for presenting said displays in a single graphical user interface at said client.

60. The network-based system of claim 52, wherein said instructions for initiating comprises instructions for determining a specific journal corresponding to the received credentials.

61. The network-based system of claim 52, wherein said instructions for transmitting the retrieved document comprise instructions for additionally generating and transmitting said document in a PDF format.

62. The network-based system of claim 52, wherein:
the retrieved document comprises a document for publication in a specific journal having a specific journal style; and
the REP includes formatting requirements for enforcing the specific journal style including restrictions on editing of HSEs.

63. The network-based system of claim 52, wherein said instructions for configuring the remote client to display a first display interface comprise instructions for displaying a proof window presenting direct user editable text of the proof document, and said instructions for configuring remote client to display a second display interface comprise instructions for displaying a navigation window presenting plural links for initiating controlled editing of specific HSEs.

64. The network-based system of claim 63, wherein said plural links are each associated with a specific task widget.

65. The method of claim 52, wherein:
said instructions for configuring the second display interface include instructions to present an author query widget providing communication with a user at the client with respect to unique locations within the user editable text, said widget presenting a form for presenting and responding to author queries; and
said instructions for configuring the first display interface include instructions to display a non-editable link within the user editable text at each unique author query location.

66. The network-based system of claim 52, wherein said REP includes specific formatting requirements for figures within the document and said instructions to configure the second display interface include instructions to display a figure widget, the figure widget presenting a form for editing figures in accordance with said REP.

67. The network-based system of claim 66, wherein said instructions to display a figure widget cause the figure widget to be configured to present a replace figure widget, the replace figure widget presenting a form for uploading a replacement figure at said client.

68. The network-based system of claim 66, wherein said instructions to display a figure widget cause the figure widget to be configured to present a figure link within said figure widget, the figure link being configured to navigate the document displayed in said first display interface to a location of the selected figure with the selected figure HSE displayed within a figure box within said first display interface in accordance with said REP.

69. The network-based system of claim 52, wherein:
said instructions to configure said second display interface include instructions to present a comment widget providing for insertion of user comments at unique locations within the user editable text, said comment widget presenting a form for inserting a comment; and
said instructions to configure said first display interface include instructions to display a non-editable link to said comment within the user editable text at each unique comment location.

70. The network-based system of claim 52, wherein said REP includes specific formatting requirements for figure citations within the document and said instructions to configure the second display interface include instructions to display a figure citation widget, the figure citation widget presenting a form for editing figures citations in accordance with said REP.

71. The network-based system of claim 52, wherein said REP includes specific formatting requirements for table citations within the document and said instructions to configure the second display interface include instructions to display a table citation widget, the table citation widget presenting a form for editing table citations in accordance with said REP.

72. The network-based system of claim 52, wherein said REP includes specific formatting requirements for reference citations within the document and said instructions to configure the second display interface include instructions to display a reference citation widget, the reference citation widget presenting a form for editing reference citations in accordance with said REP.

73. The network-based system of claim 72, wherein said instructions to display a reference citation widget include instructions for displaying a selectable menu with navigable links to references cited within the document.

74. The network-based system of claim 73, wherein reference citation editing is restricted to removing from, relocating within or inserting into the user editable text a reference citation included in said selectable menu.

75. The network-based system of claim 72, wherein said instructions to configure the first display interface include instructions to display a references section presenting reference citations in non-user editable form with associated selectable links configured to open an update reference widget, said update reference widget presenting a form for updating reference citations in accordance with a user selectable reference type and said REP.

76. The network-based system of claim 75, wherein said update reference widget includes a user selectable web search link configured to automatically conduct a web-based search for references based on user entered information contained within the update reference widget form and populate said form based on user selectable results of said search.

77. The network-based system of claim 52, wherein said REP includes specific requirements for permitted access by collaborators and said instructions to configure the second display interface include instructions to display a collaborator widget, the collaborator widget presenting selectable collaborator permissions, wherein selection of a collaborator permission initiates remote collaboration in accordance with said REP.

78. A computer-implemented method for tracking changes in XML coded files, comprising:
receiving information representing one or more changes to an original file, wherein said information comprises at least one content change and at least one attribute value associated with each said change;
processing the original file in accordance with the received content changes while maintaining the association between each said content change and said at least one associated attribute value, wherein said processing comprises tagging the file in accordance with an associated change schema for said file to produce a changed file reflecting said content changes;
receiving a change tracking request with respect to the changed file; and
generating a change tracked version of the changed file in response to said change tracking request, wherein the tracked change file represents the content changes in a denormalized tagging format.

79. The method of claim 78, wherein said generating comprises denormalizing the tagging of the changed file.

80. The method of claim 79, wherein said denormalizing comprises
defining at least one set of elements that will be closed and reopened whenever a nested element of the same set is encountered; and
redundantly tagging the changed file in accordance with said at least one defined set.

81. The method of claim 80, wherein said denormalized tagging format complies with at least one of the following rules:
i) elements within one said defined set will not exist in a parent-child or ancestor dependent relationship unless said elements have a common text node as the only descendent that is a text node; and
ii) all ancestor elements of any selected text node within one said defined set have no intervening text nodes.

82. The method of claim 78, wherein said processing comprises validating the changed file in accordance with the change schema.

83. The method of claim 78, further comprising:
transmitting said tracked changes version to a remote client; and
receiving at least one of accept or reject instructions from the remote client with respect to said content changes.

84. The method of claim 83, wherein:
said base schema comprises a first set of constraints on the structure and content of the file corresponding to a selected XML schema and
said change schema comprises said first set of constraints and at least a second set of constraints on the structure and content of the file corresponding to the selected XML schema, wherein said at least one second set of constraints comprises rules and data types governing elements and attributes for indicating content changes

85. The method of claim 83, further comprising:
accepting or rejecting content changes in accordance with said received accept or reject instructions to produce a finalized file;
validating the finalized file in accordance with a base schema.

86. The method of claim 85, further comprising hierarchically controlling said accepting or rejecting of content changes with respect to least one of nested or grouped changes.

87. The method of claim 86, wherein said hierarchically controlling comprises identifying dependent relationships among nested changes and enforcing the dependencies from outer to inner content changes.

88. The method of claim 87, wherein said enforcing is in accordance with a database specifying permitted accept and reject actions in response to initial actions with respect to nested outer and inner changes by imposing an effect on an inner change in response to a specific action on a corresponding inner change.
